(19) United States
(12) Patent Application Publication
(10) Pub. No.: US 2010/0324886 A1
(43) Pub. Date: Dec. 23, 2010

(54) PARALLEL TRANSLATION INFORMATION GENERATION DEVICE, PARALLEL TRANSLATION INFORMATION GENERATION METHOD AND PROGRAM

(76) Inventors: Rie Tanaka, Tokyo (JP); Toru Ishida, Tokyo (JP); Yohei Murakami, Tokyo (JP)

Correspondence Address: Tomoko Nakajima;Cermak Nakajima LLP, 127 S. Peyton Street, Suite 210, Alexandria, VA, 22314, US

(21) Appl. No.: 12/866,610

(22) PCT Filed: Jan. 15, 2009
(86) PCT No.: PCT/JP2009/050419

§ 371 Date: Aug. 6, 2010

(30) Foreign Application Priority Data
Feb. 13, 2008 (JP) 2008-031189

(51) Int. Cl. G06F 17/28

(52) U.S. Cl. 704/7; 704/2; 704/E11.001

(57) ABSTRACT

A parallel translation information generation device includes a bilingual dictionary storage portion in which are stored three or more types of bilingual dictionaries that link all two-language combinations of a first language, a second language, and a third language; a trilingual parallel translation information generation portion that generates trilingual parallel translation information that is a set of a word in the first language, a word in the second language, and a word in the third language having a relationship such that all sets of words in two languages among the first-language word, the second-language word, and the third-language word are linked by the bilingual dictionaries, and a trilingual parallel translation information output portion that outputs trilingual parallel translation information.

### TECHNICAL FIELD

The present invention relates to a parallel translation information generation device or the like that generates trilingual parallel translation information or the like that includes synonymous words in three languages.

### BACKGROUND ART

Conventionally, methods for generating bilingual dictionaries including synonymous words in two languages have been known (see, for example, Patent Document 1).

Patent Document 1: JP 2007-249606A

### DISCLOSURE OF INVENTION

### Problem to be Solved by the Invention

However, conventional methods for generating bilingual dictionaries are for synonymous words in two languages, and no method for generating parallel translation information including synonymous words in three or more languages was known.

The present invention has been achieved in view of the above circumstance, and it is an object of the present invention to provide a parallel translation information generation device or the like that generates parallel translation information including synonymous words in three or more languages by using bilingual dictionaries.

### Means for Solving the Problems

In order to achieve the above object, a parallel translation information generation device according to the present invention is a parallel translation information generation device including: a bilingual dictionary storage portion in which are stored three or more types of bilingual dictionaries that are each information associating words in two languages and that link all two-language combinations of a first language, a second language, and a third language; a trilingual parallel translation information generation portion that generates trilingual parallel translation information that is a set of a word in the first language, a word in the second language, and a word in the third language having a relationship such that all sets of words in two languages among the first-language word, the second-language word, and the third-language word are linked by the bilingual dictionaries stored in the bilingual dictionary storage portion; and a trilingual parallel translation information output portion that outputs the trilingual parallel translation information generated by the trilingual parallel translation information generation portion.

With this configuration, it is possible to generate the trilingual parallel translation information including synonymous words in three languages by using the bilingual dictionaries each associating words in two languages. It is also possible to use the trilingual parallel translation information for various processing.

In the parallel translation information generation device of the present invention, each of the bilingual dictionaries stored in the bilingual dictionary storage portion may have a direction from a source language to a target language, the parallel translation information generation device further may include a path setting portion that sets an interlingual path such that all two-language combinations of the first language, the second language, and the third language are linked at least in either direction, and the trilingual parallel translation information generation portion may generate the trilingual parallel translation information in which words in two languages are linked in the directions of the path set by the path setting portion.

With this configuration, it is possible to generate the trilingual parallel translation information that is a set of the first-language word, the second-language word, and the third-language word that are linked by the path set by the path setting portion.

In the parallel translation information generation device of the present invention, at least a bilingual dictionary having a direction from the first language to the second language, a bilingual dictionary having a direction from the second language to the third language, and a bilingual dictionary having a direction from the third language to the first language may be stored in the bilingual dictionary storage portion, and the path setting portion may set at least a path having the direction from the first language to the second language, the direction from the second language to the third language, and the direction from the third language to the first language.

With this configuration, it is possible to generate the trilingual parallel translation information that is a set of the first-language word, the second-language word, and the third-language word that are linked by a loop path.

In the parallel translation information generation device of the present invention, at least a bilingual dictionary having a direction from the first language to the second language, a bilingual dictionary having a direction from the first language to the third language, and a bilingual dictionary having a direction from the second language to the third language may be stored in the bilingual dictionary storage portion, and the path setting portion may set at least a path having the direction from the first language to the second language, the direction from the first language to the third language, and the direction from the second language to the third language.

With this configuration, it is possible to generate the trilingual parallel translation information that is a set of the first-language word, the second-language word, and the third-language word that are linked by a parallel path.

In the parallel translation information generation device of the present invention, four or more types of bilingual dictionaries that link two-language combinations of four or more languages may be stored in the bilingual dictionary storage portion, the trilingual parallel translation information generation portion may generate two or more types of trilingual parallel translation information that include at least two languages that are the same, and the parallel translation information generation device may further include an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and an N-language parallel translation information output portion that outputs the N-language parallel translation information generated by the N-language parallel translation information generation portion.

With this configuration, it is possible to generate the N-language parallel translation information where N is an integer of 4 or more by using the trilingual parallel translation information. Then, it is possible to use the N-language parallel translation information for various processing.

Furthermore, a parallel translation information generation device of the present invention is a parallel translation information generation device including: a bilingual dictionary storage portion in which are stored N or more types of bilingual dictionaries that are each information associating words in two languages and that link an ith language with an (i+1)th language (i is an integer of 1 to N (N is an integer of 3 or more), and an (N+1)th language is a first language); an N-language parallel translation information generation portion that generates N-language parallel translation information that is a set of words in the first language through an Nth language having a relationship such that all sets of words in two adjacent languages among the first-language word through the Nth-language word are linked by the bilingual dictionaries stored in the bilingual dictionary storage portion; and an N-language parallel translation information output portion that outputs the N-language parallel translation information generated by the N-language parallel translation information generation portion.

With this configuration, it is possible to directly generate the N-language parallel translation information by using the bilingual dictionaries each associating words in two languages. Then, it is possible to use the N-language parallel translation information for various processing.

### EFFECT OF THE INVENTION

With the parallel translation information generation device or the like of the present invention, it is possible to generate the parallel translation information including synonymous words in three or more languages by using the bilingual dictionaries.

### BEST MODE FOR CARRYING OUT THE INVENTION

Hereinafter, a parallel translation information generation device of the present invention will be descried by way of embodiments. In the following embodiments, those components and steps that are denoted by the same reference numerals are the same or corresponding components and steps, and any redundant description thereof may be omitted.

### Embodiment 1

A parallel translation information generation device according to Embodiment 1 of the present invention will be described with reference to the drawings. The parallel translation information generation device of this embodiment generates trilingual parallel translation information including synonymous words in three languages.

FIG. 1 is a block diagram showing a configuration of a parallel translation information generation device 1 according to this embodiment. The parallel translation information generation device 1 of this embodiment includes a bilingual dictionary storage portion 11, a path setting portion 12, a trilingual parallel translation information generation portion 13, and a trilingual parallel translation information output portion 14.

In the bilingual dictionary storage portion 11, bilingual dictionaries are stored. A bilingual dictionary is information associating words in two languages. Here, a word is a unit constituting a sentence, and may be, for example, a word or a morpheme in a grammatical sense, or may be a short sequence of words (idiom) in a grammatical sense.

The phrase “associating words in two languages” means that one word in a given language and another word in a different language can each be acquired from the other word. Accordingly, the bilingual dictionary may include information including a word in a given language and a word in a different language as a set, or may be information linking a word in a given language to a word in a different language. In the latter case, the bilingual dictionary may be, for example, information associating pointers or addresses indicating the locations where a word in a given language and a word in a different language are stored. This embodiment describes the former case.

For example, the bilingual dictionary is information including multiple sets of a word in a certain language and a word in a different language. The words included in such a word set are words having parallel-translation relation with each other, that is, synonymous words. For example, the bilingual dictionary may include a set including the English word “patent” and the Japanese word “ [symbol] (tokkyo)”. The bilingual dictionary may simple include sets of words having parallel-translation relation with each other, or may have the direction from a source language to a target language for those words having parallel-translation relation. In the latter case, for example, the bilingual dictionary may include a set including the word “ [symbol] (sora)” in Japanese, which is the source language, and the words “sky, air, heaven” in English, which is the target language. In that case, the bilingual dictionary is used for acquiring, from the word “ [symbol] (sora)”, the word “sky” or the like, which has parallel-translation relation with the word “ [symbol] (sora)”, but the bilingual dictionary will not be used for acquiring, from the word “sky”, the word “ [symbol] (sora)”, which has parallel-translation relation with the word “sky”. This embodiment describes the case where each of the bilingual dictionaries has the direction from the source language to the target language.

In the bilingual dictionary storage portion 11, three or more types of bilingual dictionaries that link all two-language combinations of the first language, the second language, and the third language are stored. It is assumed that the first language, the second language, and the third language are different from one another. For example, the first language may be Japanese, the second language may be English, and the third language may be German. Here, “bilingual dictionary linking two languages” means a bilingual dictionary associating a word in one of two languages with a word in the other language that has parallel-translation relation with that word. The “bilingual dictionaries that link all two-language combinations of the first language, the second language, and the third language” means a bilingual dictionary between the first language and the second language, a bilingual dictionary between the second language and the third language, and a bilingual dictionary between the third language and the first language. When the bilingual dictionaries have the direction from the source language to the target language, the bilingual dictionary having the direction from the first language to the second language and the bilingual dictionary having the direction from the second language to the first language are considered to be of different types.

There is no limitation with respect to the process in which multiple bilingual dictionaries are stored in the bilingual dictionary storage portion 11. For example, multiple bilingual dictionaries may be stored via a recording medium in the bilingual dictionary storage portion 11, or multiple bilingual dictionaries transmitted via a communications line or the like may be stored in the bilingual dictionary storage portion 11. Alternatively, multiple bilingual dictionaries that have been input via an input device may be stored in the bilingual dictionary storage portion 11. Storage in the bilingual dictionary storage portion 11 may be temporary storage in a RAM or the like, or may be long-term storage. The bilingual dictionary storage portion 11 may be implemented with a specific recording medium (for example, a semiconductor memory, a magnetic disk, or an optical disk).

The path setting portion 12 sets an interlingual path such that all two-language combinations of the first language, the second language, and the third language are linked at least in either direction. Such a path can be a loop path or a parallel path.

FIG. 2 is a diagram for illustrating a loop path. In FIG. 2, a path from a first-language word to a second-language word, a path from the second-language word to a third-language word, and a path from the third-language word to the first-language word are shown. A loop path is a path that starts at a word in a given language serving as the original, passes through words in other languages, and returns to the word in the original language. In this case, at least a bilingual dictionary having the direction from the first language to the second language, a bilingual dictionary having the direction from the second language to the third language, and a bilingual dictionary having the direction from the third language to the first language are stored in the bilingual dictionary storage portion 11, and the path setting portion 12 sets at least a path having the direction from the first language to the second language, the direction from the second language to the third language, and the direction from the third language to the first language.

FIG. 3 is a diagram for illustrating a parallel path. In FIG. 3, a path from a first-language word to a second-language word, a path from the first-language word to a third-language word, and a path from the second-language word to the third-language word are shown. A parallel path is a path in which there are different routes from a word in a language serving as the original to words in other languages. In this case, at least a bilingual dictionary having the direction from the first language to the second language, a bilingual dictionary having the direction from the first language to the third language, and a bilingual dictionary having the direction from the second language to the third language are stored in the bilingual dictionary storage portion 11, and the path setting portion 12 sets at least a path having the direction from the first language to the second language, the direction from the first language to the third language, and the direction from the second language to the third language.

Here, the arrow constituting each of the paths in the loop or parallel path corresponds to a bilingual dictionary whose direction from the source language to the target language is indicated by the orientation of that arrow. When the bilingual dictionary has no direction, this would correspond to a bilingual dictionary having a two-directional arrow in FIGS. 2 and 3, and therefore the path setting portion 12 may set a path by using either of the directions. The path setting portion 12 may set two or more paths. For example, the path setting portion 12 may set a loop path and a parallel path. In the case of setting loop paths, the path setting portion 12 may set multiple paths by varying the language serving as the starting point of the loop. For example, in the case of setting loop paths when a Japanese-English bilingual dictionary, an English-German bilingual dictionary, and a German-Japanese bilingual dictionary are stored in the bilingual dictionary storage portion 11, the path setting portion 12 may set a loop path in which Japanese is the first language (in this case, the second language is English and the third language is German), a loop path in which English is the first language (in this case, the second language is German and the third language is Japanese), and a loop path in which German is the first language (in this case, the second language is Japanese and the third language is English) in FIG. 2.

There is no particular limitation with respect to how the path setting portion 12 sets a path. For example, the path setting portion 12 may set a path by reading a loop path or a parallel path that has been stored in advance in a recording medium (not shown). Alternatively, the path setting portion 12 may refer to information indicating the type or the like of the bilingual dictionaries stored in the bilingual dictionary storage portion 11, and set a possible path by using that information. In the latter case, for example, the bilingual dictionaries may be associated with information indicating the source language and the target language, and the path setting may be performed by using that information. When capable of setting two or more paths, the path setting portion 12 may set all of the paths, or may set a portion of the paths. For example, the path setting portion 12 may accumulate information indicating a set path in a recording medium (not shown), or may add, to information indicating a path that has been stored in advance in the recording medium, a flag or the like indicating that the path has been set.

The trilingual parallel translation information generation portion 13 generates one or more pieces of trilingual parallel translation information. Here, the trilingual parallel translation information is a set of a word in the first language, a word in the second language, and a word in the third language that are synonymous with one another, as described above. In other words, the trilingual parallel translation information is a set of a word in the first language, a word in the second language, and a word in the third language having a relationship such that all two-language combinations of the first-language word, the second-language word, and the third-language word are linked by the bilingual dictionaries stored in the bilingual dictionary storage portion 11. The trilingual parallel translation information generation portion 13 generates the trilingual parallel translation information by which words in two languages are linked in the direction of the path set by the path setting portion 12. The specific processing by which the trilingual parallel translation information generation portion 13 generates the trilingual parallel translation information will be described later.

The trilingual parallel translation information output portion 14 outputs the trilingual parallel translation information generated by the trilingual parallel translation information generation portion 13. Here, this output may be, for example, output to a display device (for example, a CRT, a liquid crystal display, or the like), transmission to a specific device via a communications line, printing using a printer, accumulation in a recording medium, or transfer to another component. In this embodiment, it is assumed that the trilingual parallel translation information output portion 14 accumulates the trilingual parallel translation information in a recording medium 15. The trilingual parallel translation information output portion 14 may or may not include a device for performing output (for example, a display device or a printer). The trilingual parallel translation information output portion 14 may be implemented with hardware, or may be implemented with software such as a driver for driving the above-mentioned devices.

The bilingual dictionary storage portion 11 and the recording medium 15 may be implemented with the same recording medium, or may be implemented with separate recording media. In the former case, the area in which the bilingual dictionaries are stored serves as the bilingual dictionary storage portion 11 and the area in which the trilingual parallel translation information is stored serves as the recording medium 15.

In the following, an operation of the parallel translation information generation device 1 according to this embodiment will be described with reference to the flowchart shown in FIG. 4.

(Step S101) The trilingual parallel translation information generation portion 13 determines whether to start the processing of generating the trilingual parallel translation information. Then, if it determines to start the generation processing, the procedure moves to Step S102; otherwise, the processing of Step S101 is repeated until the trilingual parallel translation information generation portion 13 determines to start the generation processing. For example, the trilingual parallel translation information generation portion 13 may determine to start the generation of the trilingual parallel translation information when the parallel translation information generation device 1 has received an instruction to start the generation of the trilingual parallel translation information from the user or the like.

(Step S102) The path setting portion 12 sets an interlingual path.

(Step S103) The trilingual parallel translation information generation portion 13 determines whether the path setting portion 12 has been able to set a path. Then, if the path setting portion 12 has been able to set a path, the procedure moves to Step S104; otherwise, the procedure returns to Step S101.

(Step S104) The trilingual parallel translation information generation portion 13 determines whether there is a loop path. Then, if there is a loop path, the procedure moves to Step S105; otherwise, the procedure moves to Step S107.

(Step S105) The trilingual parallel translation information generation portion 13 generates the trilingual parallel translation information by using the loop path. The details of this processing will be described later with reference to the flowchart shown in FIG. 5.

(Step S106) The trilingual parallel translation information generation portion 13 determines whether trilingual parallel translation information has been generated by using all the loop paths set by the path setting portion 12. Then, if there is any other loop path for which the trilingual parallel translation information has not been generated, the procedure returns to Step S105, in which the trilingual parallel translation information is generated by using that loop path. On the other hand, if the trilingual parallel translation information has been generated by using all the loop paths, the procedure moves to Step S107.

(Step S107) The trilingual parallel translation information generation portion 13 determines whether there is a parallel path. Then, if there is a parallel path, the procedure moves to Step S108; otherwise, the procedure moves to Step S110.

(Step S108) The trilingual parallel translation information generation portion 13 generates the trilingual parallel translation information by using the parallel path. The details of this processing will be described later with reference to the flowchart shown in FIG. 6.

(Step S109) The trilingual parallel translation information generation portion 13 determines whether trilingual parallel translation information has been generated by using all the parallel paths set by the path setting portion 12. Then, if there is any other parallel path for which the trilingual parallel translation information has not been generated, the procedure returns to Step S108, in which the trilingual parallel translation information is generated by using that parallel path. On the other hand, if the trilingual parallel translation information has been generated by using all the parallel paths, the procedure moves to Step S110.

(Step S110) The trilingual parallel translation information generation portion 13 determines whether to perform the processing of merging the trilingual parallel translation information. Then, if it determines to perform the merging processing, the procedure moves to Step S111; otherwise, the procedure moves to Step S112. For example, the trilingual parallel translation information generation portion 13 may determine to perform the processing of merging the trilingual parallel translation information when the processing of generating the trilingual parallel translation information has been performed twice or more, that is, the processing of Steps S105 and S108 has been performed twice or more, and may determine not to perform the processing of merging the trilingual parallel translation information when the processing of generating the trilingual parallel translation information has been performed only once, that is, when the processing of one of Steps S105 and S108 has been performed only once.

(Step S111) The trilingual parallel translation information generation portion 13 performs the processing of merging the trilingual parallel translation information. The details of this processing will be described later with reference to the flowchart shown in FIG. 7.

(Step S112) The trilingual parallel translation information output portion 14 outputs the trilingual parallel translation information generated by the trilingual parallel translation information generation portion 13 (the merged trilingual parallel translation information if the merging processing has been performed). In this embodiment, it is assumed that the trilingual parallel translation information output portion 14 accumulates the trilingual parallel translation information in the recording medium 15, as described above. Then, the procedure returns to Step S101.

In the flowchart shown in FIG. 4, the processing ends by powering off or interruption for aborting the processing.

FIG. 5 is a flowchart showing the details of the processing of generating the trilingual parallel translation information by using the loop path in the flowchart shown in FIG. 4 (the processing of Step S105). As described above, since the loop path has been set, it is assumed that at least a bilingual dictionary having the direction from the first language to the second language, a bilingual dictionary having the direction from the second language to the third language, and a bilingual dictionary having the direction from the third language to the first language are stored in the bilingual dictionary storage portion 11. It is also assumed that the path set by the path setting portion 12 is as shown in FIG. 2 and the language serving as the starting point is the first language.

(Step S201) The trilingual parallel translation information generation portion 13 sets a counter i to 1.

(Step S202) The trilingual parallel translation information generation portion 13 uses the bilingual dictionary having the direction from the first language to the second language to identify one or more second-language words having parallel-translation relation with the ith first-language word included in that bilingual dictionary. The identified one or more second-language words may be temporarily held in a recording medium (not shown) or the like, or a flag or the like may be added to the identified words in the bilingual dictionary.

(Step S203) The trilingual parallel translation information generation portion 13 sets a counter j to 1.

(Step S204) The trilingual parallel translation information generation portion 13 uses the bilingual dictionary having the direction from the second language to the third language to identify one or more third-language words having parallel-translation relation with the jth second-language word identified in Step S202. The one or more third-language words may be temporarily held in a recording medium (not shown) or the like, or a flag or the like may be added to the identified words in the bilingual dictionary.

(Step S205) The trilingual parallel translation information generation portion 13 sets a counter k to 1.

(Step S206) The trilingual parallel translation information generation portion 13 uses the bilingual dictionary having the direction from the third language to the first language to identify one or more first-language words having parallel-translation relation with the kth third-language word identified in Step S204. The identified one or more first-language words may be temporarily held in a recording medium (not shown) or the like, or a flag or the like may be added to the identified words in the bilingual dictionary.

(Step S207) The trilingual parallel translation information generation portion 13 sets a counter m to 1.

(Step S208) The trilingual parallel translation information generation portion 13 determines whether the ith first-language word included in the bilingual dictionary having the direction from the first language to the second language is the same as the mth first-language word identified in Step S206. Then, if they are the same, the procedure moves to Step S211; otherwise, the procedure moves to Step S209.

(Step S209) The trilingual parallel translation information generation portion 13 increments the counter m by 1.

(Step S210) The trilingual parallel translation information generation portion 13 determines whether the mth word exists among the first-language words identified in Step S206. Then, if it exists, the procedure returns to Step S208; otherwise, the procedure moves to Step S212.

(Step S211) The trilingual parallel translation information generation portion 13 generates trilingual parallel translation information including the ith first-language word included in the bilingual dictionary having the direction from the first language to the second language, the jth second-language word identified in Step S202, and the kth third-language word identified in Step S204. For example, the generated trilingual parallel translation information may be temporarily stored in a recording medium (not shown).

(Step S212) The trilingual parallel translation information generation portion 13 increments the counter k by 1.

(Step S213) The trilingual parallel translation information generation portion 13 determines whether the kth word exists among the third-language words identified in Step S204. Then, if it exists, the procedure returns to Step S206; otherwise, the procedure moves to Step S214.

(Step S214) The trilingual parallel translation information generation portion 13 increments the counter j by 1.

(Step S215) The trilingual parallel translation information generation portion 13 determines whether the jth word exists among the second-language words identified in Step S202. Then, if it exists, the procedure returns to Step S204; otherwise, the procedure moves to Step S216.

(Step S216) The trilingual parallel translation information generation portion 13 increments the counter i by 1.

(Step S217) The trilingual parallel translation information generation portion 13 determines whether the ith first-language word exists in the bilingual dictionary having the direction from the first language to the second language. Then, if it exists, the procedure returns to Step S202; otherwise, the procedure returns to the flowchart shown in FIG. 4.

FIG. 6 is a flowchart showing the details of the processing of generating the trilingual parallel translation information by using a parallel path in the flowchart shown in FIG. 4 (the processing of Step S108). As described above, since a parallel path has been set, it is assumed that at least a bilingual dictionary having the direction from the first language to the second language, a bilingual dictionary having the direction from the first language to the third language, and a bilingual dictionary having the direction from the second language to the third language are stored in the bilingual dictionary storage portion 11. It is also assumed that the path set by the path setting portion 12 is as shown in FIG. 3.

(Step S301) The trilingual parallel translation information generation portion 13 sets the counter i to 1.

(Step S302) The trilingual parallel translation information generation portion 13 uses the bilingual dictionary having the direction from the first language to the second language to identify one or more second-language words having parallel-translation relation with the ith first-language word included in that bilingual dictionary. The identified one or more second-language words may be temporarily held in a recording medium (not shown) or the like, or a flag or the like may be added to the identified words in the bilingual dictionary.

(Step S303) The trilingual parallel translation information generation portion 13 uses the bilingual dictionary having the direction from the first language to the third language to identify one or more third-language words having parallel-translation relation with the ith first-language word included in the bilingual dictionary having the direction from the first language to the second language. The identified one or more third-language words may be temporarily held in a recording medium (not shown) or the like, or a flag or the like may be added to the identified words in the bilingual dictionary.

(Step S304) The trilingual parallel translation information generation portion 13 sets the counter j to 1.

(Step S305) The trilingual parallel translation information generation portion 13 uses the bilingual dictionary having the direction from the second language to the third language to identify one or more third-language words having parallel-translation relation with the jth second-language word identified in Step S302. The identified one or more third-language words may be temporarily held in a recording medium (not shown) or the like, or a flag or the like may be added to the identified words in the bilingual dictionary.

(Step S306) The trilingual parallel translation information generation portion 13 sets the counter k to 1.

(Step S307) The trilingual parallel translation information generation portion 13 determines whether the kth third-language word identified in Step S305 is included in the set of the one or more third-language words identified in Step S303. Then, if it is included, the procedure moves to Step S308; otherwise, the procedure moves to Step S309.

(Step S308) The trilingual parallel translation information generation portion 13 generates trilingual parallel translation information including the ith first-language word included in the bilingual dictionary having the direction from the first language to the second language, the jth second-language word identified in Step S302, and the kth third-language word identified in Step S305. For example, the generated trilingual parallel translation information may be temporarily stored in a recording medium (not shown).

(Step S309) The trilingual parallel translation information generation portion 13 increments the counter k by 1.

(Step S310) The trilingual parallel translation information generation portion 13 determines whether the kth word exists among the third-language words identified in Step S305. Then, if it exists, the procedure returns to Step S307; otherwise, the procedure moves to Step S311.

(Step S311) The trilingual parallel translation information generation portion 13 increments the counter j by 1.

(Step S312) The trilingual parallel translation information generation portion 13 determines whether the jth word exists among the second-language words identified in Step S302. Then, if it exists, the procedure returns to Step S305; otherwise, the procedure moves to Step S313.

(Step S313) The trilingual parallel translation information generation portion 13 increments the counter i by 1.

(Step S314) The trilingual parallel translation information generation portion 13 determines whether the ith first-language word exists in the bilingual dictionary having the direction from the first language to the second language. Then, if it exists, the procedure returns to Step S302; otherwise, the procedure returns to the flowchart shown in FIG. 4.

Note that the following processing may be performed in Step S307, in place of the above-described processing. That is, the trilingual parallel translation information generation portion 13 may determine whether the kth third-language word identified in Step S303 is included in the set of the one or more third-language words identified in Step S305. Then, if it is included, the procedure moves to Step S308; otherwise, the procedure moves to Step S309. In this case, in Step S308, the trilingual parallel translation information generation portion 13 generates trilingual parallel translation information including the ith first-language word included in the bilingual dictionary having the direction from the first language to the second language, the jth second-language word identified in Step S302, and the kth third-language word identified in Step S303.

FIG. 7 is a flowchart showing the details of the processing of merging the trilingual parallel translation information in the flowchart shown in FIG. 4 (the processing of Step S111). As described above, it is assumed that the trilingual parallel translation information generation portion 13 has performed the processing of generating the trilingual parallel translation information twice or more, and two or more pieces of trilingual parallel translation information generated by that processing are stored in a recording medium (not shown). It is also assumed that there is a recording medium in which the merged trilingual parallel translation information is temporarily stored.

(Step S401) The trilingual parallel translation information generation portion 13 sets the counter i to 1.

(Step S402) The trilingual parallel translation information generation portion 13 determines whether the ith trilingual parallel translation information stored in the recording medium (not shown) has already been added in the recording medium in which the merged trilingual parallel translation information is temporarily stored. Then, if it has already been added, the procedure moves to Step S404; otherwise, the procedure moves to Step S403.

(Step S403) The trilingual parallel translation information generation portion 13 adds the ith trilingual parallel translation information in the recording medium in which the merged trilingual parallel translation information is temporarily stored.

(Step S404) The trilingual parallel translation information generation portion 13 increments the counter i by 1.

(Step S405) The trilingual parallel translation information generation portion 13 determines whether the ith trilingual parallel translation information exists. Then, if it exists, the procedure returns to Step S402; otherwise, the procedure returns to the flowchart shown in FIG. 4.

In the following, an operation of the parallel translation information generation device 1 according to this embodiment will be described by way of a specific example. In this specific example, it is assumed that a Japanese-English bilingual dictionary, an English-German bilingual dictionary, a German-Japanese bilingual dictionary, and a Japanese-German bilingual dictionary are stored in the bilingual dictionary storage portion 11. FIG. 8 is a table showing an example of the Japanese-English bilingual dictionary used in this specific example. As shown in FIG. 8, the Japanese-English bilingual dictionary is information including multiple sets of a source language word and target language words. For example, the source language (Japanese) word “ [symbol] (sora)” is associated with the target language (English) words “sky, air, heaven”. Accordingly, using this Japanese-English bilingual dictionary makes it possible to acquire, from the Japanese word “ [symbol] (sora)”, the English words “sky”, “air”, and “heaven” that have parallel-translation relation with “ [symbol] (sora)”.

It is assumed that the user of the parallel translation information generation device 1 first inputs an instruction to generate the trilingual parallel translation information to the parallel translation information generation device 1 by using an input device such as a keyboard or a mouse. Then, the trilingual parallel translation information generation portion 13 of the parallel translation information generation device 1 accepts that information, and determines to start the processing of generating the trilingual parallel translation information (Step S101). Then, the trilingual parallel translation information generation portion 13 issues an instruction to set a path to the path setting portion 12.

Here, it is assumed that the path setting portion 12 holds the information shown in FIG. 9 in a recording medium (not shown). FIG. 9 shows information including the path type and the bilingual dictionary type in association with each other. For example, the bilingual dictionary type “first language->second language, second language->third language, third language->first language” is associated with the path type “loop”. It is assumed that “ith language->jth language” is a bilingual dictionary having the direction from the ith language to the jth language. Accordingly, the path setting portion 12 determines the first language, the second language, and the third language corresponding to “bilingual dictionary type” in the table shown in FIG. 9 by referring to the multiple bilingual dictionaries stored in the bilingual dictionary storage portion 11. In this specific example, it is assumed that the first language has been determined to be Japanese, the second language has been determined to be English, and the third language has been determined to be German by the path setting portion 12 for the loop path. It is also assumed that the first language has been determined to be Japanese, the second language has been determined to be English, and the third language has been determined to be German for the parallel path as well. Then, as shown in FIG. 10, the path setting portion 12 configures path information that is information including the path type and path identification information in association with each other in a recording medium (not shown) (Step S102). In the path information shown in FIG. 10, the path identification information includes information indicating the first language, the second language, and the third language as the information for identifying the path. Here, it is assumed that the first language is Japanese, the second language is English, and the third language is German for both the loop and parallel paths, as described above.

Then, the trilingual parallel translation information generation portion 13 determines that the setting of a path has been performed (Step S103). Since the setting of a loop path exists as shown in FIG. 10, the trilingual parallel translation information generation portion 13 performs the processing of generating the trilingual parallel translation information for the loop path (Step S105).

Specifically, the trilingual parallel translation information generation portion 13 identifies one or more English words, namely, “sky”, “air”, and “heaven” corresponding to the first Japanese word “ [symbol] (sora)” by using the Japanese-English bilingual dictionary (Steps S201, S202). Then, the trilingual parallel translation information generation portion 13 accumulates the identified English words in a recording medium (not shown).

Further, the trilingual parallel translation information generation portion 13 identifies one or more German words, namely, “Himmel” and “Firmament” corresponding to the identified first English word “sky” by using the English-German bilingual dictionary (Steps S203, S204). Then, the trilingual parallel translation information generation portion 13 accumulates the identified German words in the recording medium (not shown).

Further, the trilingual parallel translation information generation portion 13 identifies one or more Japanese words, namely, “ [symbol] (sora)”, “ [symbol] (ten)”, “ [symbol] (kyuryu)”, “ [symbol] (kiko)” . . . corresponding to the identified first German word “Himmel” by using the German-Japanese bilingual dictionary (Steps S205, S206). Then, the trilingual parallel translation information generation portion 13 accumulates the identified Japanese words in the recording medium (not shown).

Further, the trilingual parallel translation information generation portion 13 determines that the first word “ [symbol] (sora)” included in the Japanese-English bilingual dictionary and the first Japanese word “ [symbol] (sora)” identified by using the German-Japanese bilingual dictionary match (Steps S207, S208), and generates trilingual parallel translation information including “ [symbol] (sora)”, “sky”, and “Himmel” (Step S211). Then, the trilingual parallel translation information generation portion 13 accumulates the generated trilingual parallel translation information in the recording medium (not shown).

By repeatedly performing such processing, the generation of the trilingual parallel translation information by using a loop path is performed (Steps S202 to S217). FIG. 11 is a table showing an example of the multiple trilingual parallel translation information pieces generated from a loop path in such manner. As can be clearly seen from FIG. 10, there is only one loop path, and therefore the generation of trilingual parallel translation information for a parallel path will be performed (Steps S106, S107, S108).

Specifically, the trilingual parallel translation information generation portion 13 identifies one or more English words, namely, “sky”, “air”, and “heaven” corresponding to the first Japanese word “ [symbol] (sora)” by using the Japanese-English bilingual dictionary (Steps S301, S302). Then, the trilingual parallel translation information generation portion 13 accumulates the identified English words in the recording medium (not shown).

Further, the trilingual parallel translation information generation portion 13 identifies one or more German words, namely, “Himmel”, “Firmament”, and “Luft” corresponding to the first Japanese word “ [symbol] (sora)” in the Japanese-English bilingual dictionary by using the Japanese-German bilingual dictionary (Step S303). Then, the trilingual parallel translation information generation portion 13 accumulates the identified German words in the recording medium (not shown).

Further, the trilingual parallel translation information generation portion 13 identifies one or more German words, namely, “Himmel” and “Firmament” corresponding to the identified first English word “sky” by using the English-German bilingual dictionary (Steps S304, S305). Then, the trilingual parallel translation information generation portion 13 accumulates the identified German words in the recording medium (not shown).

Further, the trilingual parallel translation information generation portion 13 determines that the first German word “Himmel” identified by using the English-German bilingual dictionary is included in the one or more German words “Himmel”, “Firmament”, and “Luft” identified by using the Japanese-German bilingual dictionary (Steps S306, S307), and generates trilingual parallel translation information including “ [symbol] (sora)”, “sky”, and “Himmel” (Step S308). Then, the trilingual parallel translation information generation portion 13 accumulates the generated trilingual parallel translation information in the recording medium (not shown).

By repeatedly performing such processing, the generation of the trilingual parallel translation information by using a parallel path is performed (Steps S302 to S314). FIG. 12 is a table showing an example of the multiple trilingual parallel translation information pieces generated from a parallel path in such manner. As can be clearly seen from FIG. 10, there is only one parallel path (Step S109), and therefore the processing of merging the trilingual parallel translation information will be performed (Steps S110, S111).

Specifically, before stating the merging processing, the trilingual parallel translation information generation portion 13 configures information in which the trilingual parallel translation information shown in FIG. 11 and the trilingual parallel translation information shown in FIG. 12 are simply combined. Then, the trilingual parallel translation information generation portion 13 determines that the first trilingual parallel translation information “ [symbol] (sora)” “sky” “Himmel” of the combined information has not been added as merged information (Steps S401, S402), and adds that trilingual parallel translation information to the merged information (Step S403). Thereafter, the trilingual parallel translation information generation portion 13 also repeatedly performs the same processing (Steps S402 to S405). Then, for example, when the trilingual parallel translation information “ [symbol] (sora)” “sky” “Himmel” appears once again, the trilingual parallel translation information generation portion 13 searches the merged information, and determines the trilingual parallel translation information “ [symbol] (sora)” “sky” “Himmel” has already been added since it is already included, and therefore the trilingual parallel translation information generation portion 13 will not perform the processing of adding that trilingual parallel translation information (Step S402). Thus, the merging of the trilingual parallel translation information is performed.

Thereafter, the trilingual parallel translation information output portion 14 accumulates the merged trilingual parallel translation information in the recording medium 15 (Step S112). Thus, the trilingual parallel translation information is generated and output.

In this embodiment, the processing of merging the trilingual parallel translation information and the processing of outputting the trilingual parallel translation information are described as separate processes. However, the trilingual parallel translation information output portion 14 may accumulate the merged trilingual parallel translation information directly in the recording medium 15.

Here, for the trilingual parallel translation information generated by using the parallel translation information generation device 1 according to this embodiment, a description will be given of “precision” that indicates how many of the extracted word sets in three languages are truly synonymous sets, and “recall” that indicates how many of the word sets in three languages that are supposed to exist could be extracted.

Precision

Theoretically, even if trilingual parallel translation information is generated from bilingual dictionaries, the three words included in that trilingual parallel translation information may have no meaning in common. For example, in the case where a Japanese word, an English word, and a German word are included in the trilingual parallel translation information, there is a possibility of the parallel translation information generation device 1 of this embodiment generating trilingual parallel translation information including those three words even if the Japanese word has meaning 1 and meaning 2, the English word has meaning 2 and meaning 3, and the German word has meaning 3 and meaning 1. However, in that case, the three words included in that trilingual parallel translation information will have no meaning in common.

In evaluation tests, evaluation was performed for 100 sets of trilingual parallel translation information that had been randomly extracted from 35000 sets of trilingual parallel translation information generated by using a Japanese-English bilingual dictionary, a Japanese-German bilingual dictionary, and an English-German bilingual dictionary. As a result, the number of the trilingual parallel translation information pieces having no meaning in common was 0. Thus, it can be seen that the method for generating the trilingual parallel translation information according to this embodiment can achieve high precision.

Recall

Assuming that there are three words in three languages having a meaning in common and each of the words is included in bilingual dictionaries without fail, parallel-translation relation holds between each pair formed by the three words. Accordingly, in that case, the three words will be linked by a loop path or a parallel path, and therefore trilingual parallel translation information including the three words is generated. Therefore, it can be seen that the method for generating the trilingual parallel translation information according to this embodiment can achieve high recall.

As described above, with the parallel translation information generation device 1 according to this embodiment, it is possible to generate trilingual parallel translation information including synonymous words in three languages by using bilingual dictionaries that are each information associating words in two languages having parallel-translation relation. Then, it is possible to use the trilingual parallel translation information for various processing.

It should be appreciated that, in this embodiment, the generation of the trilingual parallel translation information may be performed by using only a loop path, or by using only a parallel path. Furthermore, in the case where a path is pre-set and it is not possible that any other path will be set, the parallel translation information generation device 1 does not include the path setting portion 12, and the trilingual parallel translation information generation portion 13 may generate the trilingual parallel translation information by using the pre-set path.

Here, the use of the trilingual parallel translation information generated by the parallel translation information generation device 1 will be briefly described.

Use in Serial Bilingual Machine Translation

For example, even if machine translation from the first language into the third language is not available, serially using bilingual machine translation makes it possible to perform machine translation from the first language into the third language by performing machine translation from the first language into the second language, and performing machine translation from the second language into the third language. However, as a result of performing machine translation from the first language into the second language and machine translation from the second language into the third language, the meaning of the word in the first language may change.

For example, let us consider the case where the Japanese word “ [symbol] (i)” (which means “mistake”) has been machine translated into the English word “fault”, and the English word “fault” has been machine translated into the German word “Schuld”. Here, the German word “Schuld” means “responsibility”. In this case, when the trilingual parallel translation information “ [symbol] (ayamachi), fault, Fehler” has been generated, the German word “Schuld” can be replaced by “Fehler” at the time of serial machine translation. By doing so, it is possible to avoid situations where drift of the meaning occurs even if machine translation is serially used.

Use in Back Translation

By using bilingual machine translation in the opposite direction in addition to using it serially, it is possible to perform back translation. The back translation is performed, for example, when two people who speak different languages talk to each other via machine translation. For example, the first language is machine translated into the second language, and the second language is further machine translated into the third language. Thereafter, the third language is machine translated into the second language, and the second language is further machine translated into the first language. In that case, a certain word may be translated round-trip into another word in machine translation in the direction from the first language to the third language and machine translation in the direction from the third language in the first language.

For example, it is assumed that the Japanese word “ [symbol] (sora)” is machine translated into the English word “sky”, and the English word “sky” is machine translated into the German word “Himmel”. Thereafter, the German word “Himmel” is machine translated into the English word “heaven”, and the English word “heaven” is machine translated into the Japanese word “ [symbol] (tengoku)”. In this case, the Japanese word “ [symbol] (sora)” has become “ [symbol] (tengoku)” after the back translation. In this case as well, by using the trilingual parallel translation information “ [symbol] (sora), sky, Himmel”, it is possible to perform machine translation such that the German word “Himmel” is machine translated into the English word “sky” and the English word “sky” is machine translated into the Japanese word “ [symbol] (sora)” at the time of performing machine translation from the third language into the first language.

Use as Synonym Dictionary for Different Languages

The trilingual parallel translation information generated by the parallel translation information generation device 1 can be used as a synonym dictionary for three different languages. For example, a user who can understand Japanese and English does not clearly understand whether the German word “Fehler” means “responsibility” or “fault” simply by looking at the correspondence between the English word “fault” and the German word “Fehler” by using an English-German dictionary. On the other hand, the user can understand that the German word “Fehler” means “fault” by looking at the trilingual parallel translation information including the Japanese word “ [symbol] (ayamachi)”, the English word “fault”, and the German word “Fehler”.

It should be appreciated that the trilingual parallel translation information can be applied to usages other than those described above. N-language parallel translation information is discussed in the embodiments described below, and the N-language parallel translation information can also be used for serial bilingual machine translation or the like, as in the above description. For example, for serial machine translation, the N-language parallel translation information can be used for serial machine translation between N languages using bilingual machine translation.

### Embodiment 2

A parallel translation information generation device according to Embodiment 2 of the present invention will be described with reference to the drawings. The parallel translation information generation device of this embodiment generates N-language parallel translation information (N is an integer of 4 or more) from trilingual parallel translation information.

FIG. 13 is a block diagram showing a configuration of a parallel translation information generation device 2 according to this embodiment. The parallel translation information generation device 2 of this embodiment includes a bilingual dictionary storage portion 11, a path setting portion 12, a trilingual parallel translation information generation portion 13, a trilingual parallel translation information output portion 14, an N-language parallel translation information generation portion 21, and an N-language parallel translation information output portion 22. Note that the configuration and operation of the components other than the N-language parallel translation information generation portion 21 and the N-language parallel translation information output portion 22 are the same as those in Embodiment 1, and therefore the description thereof has been omitted. However, four or more types of bilingual dictionaries linking two languages among four or more different languages are stored in the bilingual dictionary storage portion 11. In this embodiment as well, the trilingual parallel translation information output portion 14 accumulates the trilingual parallel translation information in a recording medium 15.

The N-language parallel translation information generation portion 21 merges two or more pieces of trilingual parallel translation information including the same words in at least two languages by using the two or more types of trilingual parallel translation information output by the trilingual parallel translation information output portion 14, and generates N-language parallel translation information (N is an integer of 4 or more) that is a set of words in N or more languages. For example, when trilingual parallel translation information (which is referred to as “first trilingual parallel translation information”) that is a set of words in the first language, the second language, and the third language and trilingual parallel translation information (which is referred to as “second trilingual parallel translation information”) that is a set of words in the first language, the second language, and the fourth language have been output by the trilingual parallel translation information output portion 14, the N-language parallel translation information generation portion 21 may combine the first trilingual parallel translation information and the second trilingual parallel translation information that include the first-language word and second-language word in common, thereby generating four-language parallel translation information including the common first-language word and second-language word, the third-language word included in the first trilingual parallel translation information, and the fourth-language word included in the second trilingual parallel translation information.

The N-language parallel translation information output portion 22 outputs the N-language parallel translation information generated by the N-language parallel translation information generation portion 21. Here, this output may be, for example, output to a display device (for example, a CRT, a liquid crystal display, or the like), transmission to a specific device via a communications line, printing using a printer, accumulation in a recording medium, or transfer to another component. In this embodiment, it is assumed that the N-language parallel translation information output portion 22 accumulates the N-language parallel translation information in a recording medium 23. The N-language parallel translation information output portion 22 may or may not include a device for performing output (for example, a display device or a printer). The N-language parallel translation information output portion 22 may be implemented with hardware, or may be implemented with software such as a driver for driving the above-mentioned devices.

The bilingual dictionary storage portion 11, the recording medium 15, and the recording medium 23 may be implemented with the same recording medium, or may be implemented with separate recording media. In the former case, the area in which the bilingual dictionaries are stored serves as the bilingual dictionary storage portion 11, the area in which the trilingual parallel translation information is stored serves as the recording medium 15, and the area in which the N-language parallel translation information is stored serves as the recording medium 23.

In the following, an operation of the parallel translation information generation device 2 according to this embodiment will be described with reference to the flowchart shown in FIG. 14.

(Step S501) The trilingual parallel translation information generation portion 13 determines whether to start the processing of generating the trilingual parallel translation information. Then, if it determines to start the generation processing, the procedure moves to Step S502; otherwise, the processing of Step S501 is repeated until it determines to start the generation processing. For example, the trilingual parallel translation information generation portion 13 may determine to start the generation of the trilingual parallel translation information when the parallel translation information generation device 2 has accepted an instruction to start the generation of the N-language parallel translation information from the user or the like.

(Step S502) The trilingual parallel translation information generation portion 13 and so forth perform the processing of generating and outputting the trilingual parallel translation information. This processing is the same as the processing of Steps S102 to S112 in the flowchart shown in FIG. 4, and therefore the description thereof has been omitted. In this embodiment, it is assumed that the N-language parallel translation information is generated by using multiple types of trilingual parallel translation information, and therefore the trilingual parallel translation information generation portion 13 generates two or more types of trilingual parallel translation information. For example, the trilingual parallel translation information generation portion 13 may generate a first-type trilingual parallel translation information that is a set of a first-language word, a second-language word, and a third-language word, and second-type trilingual parallel translation information that is a set of a first-language word, a second-language word, and a fourth-language word. Here, the “type” of trilingual parallel translation information can be determined by the set of languages of the words included in that trilingual parallel translation information. As described above, the trilingual parallel translation information that is a set of a first-language word, a second-language word, and a third-language word and the trilingual parallel translation information that is a set of a first-language word, a second-language word, and a fourth-language word have different word language sets, namely, (the first language, the second language, the third language) and (the first language, the second language, the fourth language), and therefore the types of these two pieces of trilingual parallel translation information are different. In addition, it is assumed that bilingual dictionaries that are sufficient to generate such two or more types of trilingual parallel translation information are stored in the bilingual dictionary storage portion 11.

(Step S503) The N-language parallel translation information generation portion 21 and the N-language parallel translation information output portion 22 perform the processing of generating and outputting the N-language parallel translation information. Then, the procedure returns to Step S501. The details of this processing will be described later with reference to the flowchart shown in FIG. 15.

In the flowchart shown in FIG. 14, the processing ends by powering off or interruption for aborting the processing.

FIG. 15 is a flowchart showing the details of the processing of generating and outputting the N-language parallel translation information in the flowchart shown in FIG. 14 (the processing of Step S503). As described above, it is assumed that multiple types of trilingual parallel translation information are generated and stored in the recording medium 15.

(Step S601) The N-language parallel translation information generation portion 21 determines whether two or more types of trilingual parallel translation information including two languages in common exist in the recording medium 15. Then, if they exist, the procedure moves to Step S602; otherwise, the procedure returns to the flowchart shown in FIG. 14 since N-language parallel translation information cannot be generated. For example, when the first-type trilingual parallel translation information that is a set of a first-language word, a second-language word, and a third-language word and the second-type trilingual parallel translation information that is a set of a first-language word, a second-language word, and a fourth-language word are stored in the recording medium 15, the N-language parallel translation information generation portion 21 determines that two or more types of trilingual parallel translation information including two languages in common exist in the recording medium 15 since the two types of trilingual parallel translation information includes the first language and the second language in common. On the other hand, for example, when the first-type trilingual parallel translation information that is a set of a first-language word, a second-language word, and a third-language word and the second-type trilingual parallel translation information that is a set of a first-language word, a fourth-language word, and a fifth-language word are stored in the recording medium 15, the N-language parallel translation information generation portion 21 determines that two or more types of trilingual parallel translation information including two languages in common do not exist in the recording medium 15 since the two types of the trilingual parallel translation information include only the first language in common.

(Step S602) The N-language parallel translation information generation portion 21 sets a counter i to 1.

(Step S603) The N-language parallel translation information generation portion 21 identifies, in the ith first-type trilingual parallel translation information of the two or more types of trilingual parallel translation information including two languages in common, two words in the languages that are common to another one of the types of trilingual parallel translation information. The identified two words may be temporarily held in a recording medium (not shown) or the like, or a flag or the like may be added to the identified words in the trilingual parallel translation information.

(Step S604) The N-language parallel translation information generation portion 21 sets a counter j to 2.

(Step S605) The N-language parallel translation information generation portion 21 sets a counter k to 1.

(Step S606) The N-language parallel translation information generation portion 21 determines whether the kth jth-type trilingual parallel translation information of the two or more types of trilingual parallel translation information including two languages in common includes the two words identified in Step S603. Then, it if includes the two words, the procedure moves to Step S607; otherwise, the procedure moves to Step S608.

(Step S607) The N-language parallel translation information generation portion 21 temporarily stores, in a recording medium (not shown), the word other than the two words identified in Step S603 in the kth jth-type trilingual parallel translation information of the two or more types of trilingual parallel translation information including two languages in common.

(Step S608) The N-language parallel translation information generation portion 21 increments the counter k by 1.

(Step S609) The N-language parallel translation information generation portion 21 determines whether the kth jth-type trilingual parallel translation information of the two or more types of trilingual parallel translation information including two languages in common exists in the recording medium 15. Then, if it exists, the procedure returns to Step S606, and if it does not exist, the procedure moves to Step S610.

(Step S610) The N-language parallel translation information generation portion 21 increments the counter j by 1.

(Step S611) The N-language parallel translation information generation portion 21 determines whether the jth-type trilingual parallel translation information exists in the two or more types of trilingual parallel translation information including two languages in common. Then, if it exists, the procedure returns to Step S605, and if it does not exist, the procedure moves to Step S612.

(Step S612) The N-language parallel translation information generation portion 21 generates N-language parallel translation information. Specifically, the N-language parallel translation information generation portion 21 generates N-language parallel translation information that includes the three words included in the ith first-type trilingual parallel translation information of the two or more types of trilingual parallel translation information including two languages in common, and the words that are temporarily stored in Step S607 and are included in the two or more types of trilingual parallel translation information.

For example, when the three words included in the ith first-type trilingual parallel translation information are word 1-1, word 2-1, and word 3-1, the word that is temporarily stored in Step S607 and is included in the second-type trilingual parallel translation information is word 4-1, and the word that is temporarily stored in Step S607 and is included in the third-type trilingual parallel translation information is word 5-1, the N-language parallel translation information generation portion 21 generates five-language parallel translation information including word 1-1, word 2-1, word 3-1, word 4-1, and word 5-1. When multiple words included in the second-type trilingual parallel translation information are temporarily stored in Step S607, or in other words, when word 4-1 and word 4-2 are temporarily stored in Step S607, two pieces of N-language parallel translation information (in this example, five-language parallel translation information) that respectively include these words are configured. Specifically, the N-language parallel translation information generation portion 21 generates five-language parallel translation information including word 1-1, word 2-1, word 3-1, word 4-1, and word 5-1, and five-language parallel translation information including word 1-1, word 2-1, word 3-1, word 4-2, and word 5-1.

In the case where three or more types of trilingual parallel translation information including two languages in common exist, a word included in the second-type trilingual parallel translation information has been temporarily stored in Step S607, and a word included in the third-type trilingual parallel translation information has not been temporarily stored in Step S607, the N-language parallel translation information generation portion 21 may generate four-language parallel translation information, or may not generate four-language parallel translation information. In the former case, the N-language parallel translation information generation portion 21 generates N-language parallel translation information and K-language parallel translation information (K is an integer of 4 or more and less than N) when N types of trilingual parallel translation information including two languages in common exist. In the latter case, the N-language parallel translation information generation portion 21 generates only N-language parallel translation information when N types of trilingual parallel translation information including two languages in common exist. After the N-language parallel translation information generation portion 21 has generated N-language parallel translation information, the words temporarily stored in Step S607 may be cleared.

(Step S613) The N-language parallel translation information generation portion 21 increments the counter i by 1.

(Step S614) The N-language parallel translation information generation portion 21 determines whether the ith first-type trilingual parallel translation information exists in the two or more types of trilingual parallel translation information including two languages in common. Then, if it exists, the procedure returns to Step S603, and if it does not exist, the procedure moves to Step S615.

(Step S615) The N-language parallel translation information output portion 22 outputs the N-language parallel translation information generated by the N-language parallel translation information generation portion 21. Then, the procedure returns to the flowchart shown in FIG. 14.

In the following, an operation of the parallel translation information generation device 2 according to this embodiment will be described by way of a specific example. In this specific example, the operation from generating the trilingual parallel translation information to outputting the information is the same as that in the specific example in Embodiment 1, and therefore the description thereof has been omitted. Here, it is assumed that the trilingual parallel translation information shown in FIG. 11 and the trilingual parallel translation information shown in FIG. 16 are generated, and stored in the recording medium 15. The trilingual parallel translation information shown in FIG. 11 includes sets of a Japanese word, an English word, and a German word. The trilingual parallel translation information shown in FIG. 16 includes sets of a Japanese word, an English word, and a French word.

It is assumed that the operation of generating and outputting the N-language parallel translation information (Step S503) has been started. Then, the N-language parallel translation information generation portion 21 determines that two or more types of trilingual parallel translation information including Japanese and English in common are stored in the recording medium 15 (Step S601), identifies, in the first first-type trilingual parallel translation information, that is, the first record in the trilingual parallel translation information shown in FIG. 11, the two words “ [symbol] (sora)” and “sky” in Japanese and English, which are the languages common to the other type of trilingual parallel translation information (shown in FIG. 16), and accumulates these two words in a recording medium (not shown) (Steps S602, S603).

Next, the N-language parallel translation information generation portion determines that the first second-type trilingual parallel translation information, that is, the first record in the trilingual parallel translation information in FIG. 16 includes the identified two words “ [symbol] (sora)” and “sky” (Steps S604 to S606), and temporarily stores the word “ciel”, which is the word other than the identified two words in the recording medium (not shown) (Step S607). After the same processing has been performed for all the second-type trilingual parallel translation information (Steps S605 to S611), the N-language parallel translation information generation portion 21 generates N-language parallel translation information (Step S612). Specifically, as shown in FIG. 17, the N-language parallel translation information generation portion 21 generates Japanese-English-German-French four-language parallel translation information including the three words of the first-type trilingual parallel translation information including “ [symbol] (sora)” and “sky” in common, that is, the Japanese-English-German trilingual parallel translation information, and the word “ciel”, which has been temporarily stored and is included in the second-type trilingual parallel translation information, that is, the Japanese-English-French trilingual parallel translation information. The generated four-language parallel translation information is temporarily stored in the recording medium (not shown). Thereafter, the same processing is also performed for the second and subsequent records in the trilingual parallel translation information shown in FIG. 11 (Steps S603 to S614). Then, one or more pieces of four-language parallel translation information including the four-language parallel translation information “ [symbol] (sora), sky, Himmel, ciel” are accumulated in the recording medium 23 (Step S615).

As described above, with the parallel translation information generation device 2 according to this embodiment, it is possible to generate and output N-language parallel translation information (N is an integer of 4 or more) by using the trilingual parallel translation information. Then, it is possible to use the N-language parallel translation information for various processing.

This embodiment described the case where, if the first-language words and the second-language words match in two types of trilingual parallel translation information as shown in FIGS. 18 and 19, four-language parallel translation information that is a set of the first-language word, the second-language word, the third-language word, and the fourth-language word included in the two pieces of trilingual parallel translation information is configured; however, this need not be the case. For example, when the words in the common languages are associated by bilingual dictionaries that are the same (in FIG. 18, the bilingual dictionaries having the direction from the first language to the second language) in two types of trilingual parallel translation information as shown in FIG. 18, the generation of the four-language parallel translation information by using the two types of trilingual parallel translation information may be performed. When the words in the common languages are associated by different bilingual dictionaries (in FIG. 19, the bilingual dictionary having the direction from the first language to the second language and the bilingual dictionary having the direction from the second language to the first language) in two types of trilingual parallel translation information as shown in FIG. 19, the generation of the four-language parallel translation information by using the two types of trilingual parallel translation information may not be performed. Although the cases where the paths are loop paths are shown in FIGS. 18 and 19, the same applies to the case where the paths are parallel paths. Further, the same also applies to the case of generating N-language parallel translation information where N is an integer of 5 or more.

### Embodiment 3

A parallel translation information generation device according to Embodiment 3 of the present invention will be described with reference to the drawings. The parallel translation information generation device according to this embodiment generates N-language parallel translation information by using bilingual dictionaries each associating words in two languages. However, N is an integer of 3 or more, and where N is equal to 3, the parallel translation information generation device according to this embodiment is the same as the parallel translation information generation device 1 according to Embodiment 1.

FIG. 20 is a block diagram showing a configuration of a parallel translation information generation device 3 according to this embodiment. The parallel translation information generation device 3 of this embodiment includes a bilingual dictionary storage portion 31, a path setting portion 32, an N-language parallel translation information generation portion 33, and an N-language parallel translation information output portion 34.

In the bilingual dictionary storage portion 31, bilingual dictionaries that are each information associating words in two languages are stored, as with the bilingual dictionary storage portion 11 according to Embodiment 1. In addition, it is assumed that N or more types of bilingual dictionaries linking the ith language with the (i+1)th language are stored in the bilingual dictionary storage portion 31. Here, it is assumed that i is an integer of 1 to N, and the (N+1)th language is the first language. For example, when N is equal to 5, a bilingual dictionary associating the first language with the second language, a bilingual dictionary associating the second language with the third language, a bilingual dictionary associating the third language with the fourth language, a bilingual dictionary associating the fourth language with the fifth language, and a bilingual dictionary associating the fifth language with the first language are stored in the bilingual dictionary storage portion 31.

There is no limitation with respect to the process in which multiple bilingual dictionaries are stored in the bilingual dictionary storage portion 31. For example, multiple bilingual dictionaries may be stored via a recording medium in the bilingual dictionary storage portion 31, or multiple bilingual dictionaries transmitted via a communications line or the like may be stored in the bilingual dictionary storage portion 31. Alternatively, multiple bilingual dictionaries that have been input via an input device may be stored in the bilingual dictionary storage portion 31. Storage in the bilingual dictionary storage portion 31 may be temporary storage in a RAM or the like, or may be long-term storage. The bilingual dictionary storage portion 31 may be implemented with a specific recording medium (for example, a semiconductor memory, a magnetic disk, or an optical disk).

The path setting portion 32 sets an interlingual path such that the ith language and the (i+1)th language are linked in at least in either direction. However, it is assumed that i is an integer of 1 to N, and the (N+1)th language is the first language, as described above.

This path may be a loop path or a parallel path, as described in Embodiment 1. As shown in FIG. 21, a loop path where N is an integer of 4 or more is a path in which a word in each language is linked with words in other languages by a bilingual dictionary in which that language of the word is the source language and a bilingual dictionary in which that language of the word is the target language. On the other hand, as shown in FIG. 22, a parallel path where N is an integer of 4 or more is a path in which a word in a given language (in FIG. 22, the second-language word and the fourth-language word) is linked with words in other languages by a bilingual dictionary in which that language of the word is the source language and a bilingual dictionary in which that language of the word is the target language, a word in another language (in FIG. 22, the first-language word) is linked with words in other languages only by bilingual dictionaries in which that language of the word is the source language, and a word in yet another language (in FIG. 22, the third-language word) is linked with words in other languages only by bilingual dictionaries in which that language of the word is the target language. Note that the method by which the path setting portion 32 sets a path is the same as the method by which the path setting portion 12 sets a path in Embodiment 1 except that the setting of a path between three languages is replaced by the setting of a path between N languages.

The N-language parallel translation information generation portion 33 generates N-language parallel translation information that is a set of words in the first language through the Nth language having a relationship such that all sets of words in two adjacent languages among the first-language word through the Nth-language word are linked by the bilingual dictionaries stored in the bilingual dictionary storage portion 31. That is, the N-language parallel translation information includes a word in the first language, a word in the second language, . . . , a word in the (N−1)th language, and a word in the Nth language. Two adjacent languages means the ith language and the (i+1)th language. Here, it is also assumed that i is an integer of 1 to N, and the (N+1)th language is the first language, as described above. Note that the generation of the N-language parallel translation information can also be performed in the same manner as with the trilingual parallel translation information generation portion 13 of Embodiment 1.

The N-language parallel translation information output portion 34 outputs the N-language parallel translation information generated by the N-language parallel translation information generation portion 33. Here, this output may be, for example, output to a display device (for example, a CRT, a liquid crystal display, or the like), transmission to a specific device via a communications line, printing using a printer, accumulation in a recording medium, or transfer to another component. In this embodiment, it is assumed that the N-language parallel translation information output portion 34 accumulates the N-language parallel translation information in a recording medium 35. The N-language parallel translation information output portion 34 may or may not include a device for performing output (for example, a display device or a printer). The N-language parallel translation information output portion 34 may be implemented with hardware, or may be implemented with software such as a driver for driving the above-mentioned devices.

The bilingual dictionary storage portion 31 and the recording medium 35 may be implemented with the same recording medium, or may be implemented with separate recording media. In the former case, the area in which the bilingual dictionaries are stored serves as the bilingual dictionary storage portion 31 and the area in which the trilingual parallel translation information is stored serves as the recording medium 35.

FIG. 23 is a flowchart showing an operation of the parallel translation information generation device 3 according to this embodiment. The flowchart shown in FIG. 23 is the same as the flowchart shown in FIG. 4 of Embodiment 1 except that N-language parallel translation information instead of the trilingual parallel translation information is generated and output, and therefore the description thereof has been omitted. For example, in Step S705 and Step S708 as well, N-language parallel translation information for a loop path and N-language parallel translation information for a parallel path are generated as with the flowcharts shown in FIGS. 5 and 6 of Embodiment 1.

A specific example of the operation of the parallel translation information generation device 3 of this embodiment is also the same as that of the specific example in Embodiment 1 except that the generation of the trilingual parallel translation information is replaced by the generation of the N-language parallel translation information, and therefore the description thereof has been omitted.

As described above, with the parallel translation information generation device 3 according to this embodiment, it is possible to generate the N-language parallel translation information directly from the bilingual dictionaries each associating words in two languages having parallel-translation relation. Then, it is possible to use the N-language parallel translation information for various processing.

It should be appreciated that, in this embodiment, the generation of the N-language parallel translation information may be performed by using only a loop path, or by using only a parallel path. Furthermore, in the case where a path is pre-set and it is not possible that any other path will be set, the parallel translation information generation device 3 does not include the path setting portion 32, and the N-language parallel translation information generation portion 33 may generate the N-language parallel translation information by using the pre-set path.

It should be appreciated that the specific data and the like shown in each of the above-described embodiments are examples given for illustrating the processing details and the like, and may vary depending on the circumstances. For example, trilingual parallel translation information and N-language parallel translation information that are different from those described above may be generated by using different bilingual dictionaries.

In each of the above-described embodiments, the case was described where the parallel translation information generation devices 1, 2, and 3 are a stand-alone device. However, the parallel translation information generation devices 1, 2, and 3 may be a stand-alone device, or may be a server device in a server/client system. In the latter case, the output portion and the like may output information via a communications line.

In each of the above-described embodiments, each process or each function may be implemented by centralized processing by a single device or system, or alternatively, may be implemented by distributed processing by multiple devices or systems.

In each of the above-described embodiments, the information relating to the processing performed by each of the components, such as the information accepted, acquired, selected, generated, transmitted, or received, and the information used by each of the components during processing, such as a threshold value, a numerical formula, or an address may be held temporarily, or for a long period of time in a recording medium (not shown) even if not specified in the description above. Accumulation of the information in the storage medium (not shown) may be performed by each of the components, or by an accumulating portion (not shown). Reading of the information from the storage medium (not shown) may be performed by each of the components, or by a reading portion (not shown).

In each of the above-described embodiments, when the information used in each of the components and the like, including, for example, a threshold value, or an address used in each of the components, and various set values or the like may be altered by the user, the user may or may not be able to alter such information as needed even in a case that has not been specified in the above description. When the user is able to alter such information, such alteration may be realized, for example, by an accepting portion (not shown) that accepts an alteration instruction from the user and an alteration portion (not shown) that alters the information in accordance with such an alteration instruction. Acceptance of such an alteration instruction by the accepting portion (not shown) may be, for example, acceptance from an input device, reception of information transmitted via a communications line, or acceptance of information read from a specific recording medium.

In each of the above-described embodiments, when two or more components included in the parallel translation information generation devices 1, 2, and 3 include a communication device, an input device, and the like, the two or more components may physically include a single device, or may include separate devices.

In each of the above-described embodiments, each of the components may be configured with dedicated hardware, or alternatively, components that can be implemented with software may be implemented by executing a program. For example, each of the components may be implemented with a program executing portion such as a CPU reading and executing a software program stored in a recording medium such as a hard disk or a semiconductor memory. The software that implements the parallel translation information generation device 1 in the above-described embodiments may be the following program. That is, this program is a program for causing a computer to function as: a trilingual parallel translation information generation portion that generates trilingual parallel translation information that is a set of a word in the first language, a word in the second language, and a word in the third language having a relationship such that all sets of words in two languages among the first-language word, the second-language word, and the third-language word are linked by bilingual dictionaries stored in a bilingual dictionary storage portion in which are stored three or more types of bilingual dictionaries that are each information associating words in two languages and that link all two-language combinations of the first language, the second language, and the third language; and a trilingual parallel translation information output portion that outputs the trilingual parallel translation information generated by the trilingual parallel translation information generation portion.

Further, in this program, four or more types of bilingual dictionaries that link two-language combinations of four or more languages may be stored in the bilingual dictionary storage portion, and the program may further cause the computer to function as a trilingual parallel translation information generation portion generates two or more types of trilingual parallel translation information that include at least two languages that are the same, and the parallel translation information generation device further includes an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and an N-language parallel translation information output portion that outputs the N-language parallel translation information generated by the N-language parallel translation information generation portion. By doing so, the parallel translation information generation device 2 in the above-described embodiments may be implemented.

The software that implements the parallel translation information generation device 3 in the above-described embodiments may be, for example, the following program. That is, this program is a program for causing a computer to function as: an N-language parallel translation information generation portion that generates N-language parallel translation information that is a set of words in a first language through an Nth language having a relationship such that all sets of words in two adjacent languages among the first-language word through the Nth-language (N is an integer of 3 or more) word are linked by bilingual dictionaries stored in a bilingual dictionary storage portion in which are stored N or more types of bilingual dictionaries that are each information associating words in two languages and that link an ith language with an (i+1)th language (i is an integer of 1 to N, and an (N+1)th language is the first language); and an N-language parallel translation information output portion that outputs the N-language parallel translation information generated by the N-language parallel translation information generation portion.

In the above program, the functions implemented with the above program do not include a function that can only be implemented with hardware. For example, those functions that can only be implemented with hardware such as a modem or an interface card in the output portion that outputs information, and the like are not included at least in the functions implemented with the above program.

This program may be executed by downloading from a server or the like, or may be executed by reading a program that has been recorded on a specific recording medium (for example, an optical disk such as a CD-ROM, a magnetic disk, a semiconductor memory, or the like). Further, this program may be incorporated into a product and used on that product, thus forming a program product.

The computer that executes this program may be a single computer or multiple computers. That is, centralized processing or distributed processing may be performed.

FIG. 24 is a schematic diagram showing an example of an appearance of a computer that implements the parallel translation information generation devices of the above-described embodiments by executing the above program. The above-described embodiments are implemented with computer hardware and a computer program executed on the computer hardware.

In FIG. 24, a computer system 100 includes a computer 101 including a CD-ROM (compact disk read only memory) drive 105 and an FD (flexible disk) drive 106, a keyboard 102, a mouse 103, and a monitor 104.

FIG. 25 is a diagram showing the computer system. In FIG. 25, the computer 101 includes, in addition to the CD-ROM drive 105 and the FD drive 106, a CPU (central processing unit) 111, a ROM (read only memory) 112 for storing a program such as a startup program, a RAM (random access memory) 113 that is connected to the CPU 111 and in which a command of an application program is temporarily stored and a temporary storage area is provided, a hard disk 114 in which an application program, a system program, and data are stored, and a bus 115 that connects the CPU 111, the ROM 112, and the like. The computer 101 may include a network card (not shown) for providing a connection to a LAN.

The program for causing the computer system 100 to execute the functions of the parallel translation information generation devices according to the above-described embodiments may be stored in a CD-ROM 121 or an FD 122, inserted into the CD-ROM drive 105 or the FD drive 106, and transmitted to the hard disk 114. Alternatively, the program may be transmitted to the computer 101 via a network (not shown) and stored in the hard disk 114. At the time of execution, the program is loaded into the RAM 113. The program may be loaded from the CD-ROM 121 or the FD 122, or directly from a network.

The program does not necessarily have to include, for example, an operating system (OS) or a third party program for causing the computer 101 to execute the functions of the parallel translation information generation devices according to the above-described embodiments. The program may only include a command portion to call an appropriate function (module) in a controlled mode and obtain desired results. The manner in which the computer system 100 operates is well known, and thus a detailed description thereof has been omitted.

The present invention is not limited to the embodiments set forth herein. It will be appreciated that various modifications are within the scope of the present invention.

### INDUSTRIAL APPLICABILITY

As described above, the parallel translation information generation device or the like according to the present invention makes it possible to generate parallel translation information including synonymous words in three or more languages by using bilingual dictionaries, and therefore is useful as a device or the like that generates parallel translation information including synonymous words in three or more languages.

### BRIEF DESCRIPTION OF THE DRAWINGS

FIG. 1 is a block diagram showing a configuration of a parallel translation information generation device according to Embodiment 1 of the present invention.

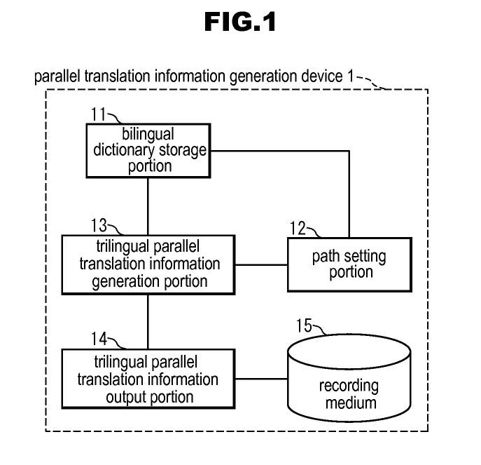

FIG. 2 is a diagram for illustrating a path in the embodiment.

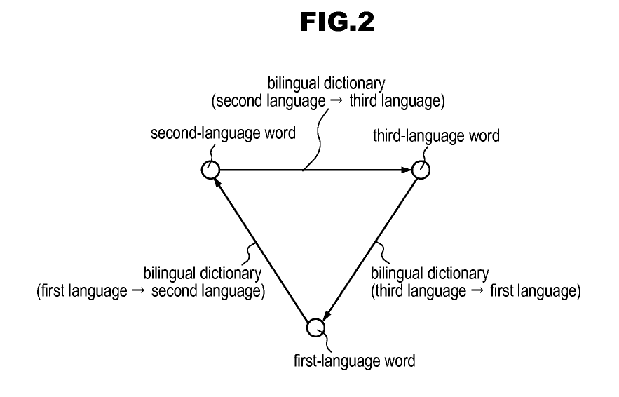

FIG. 3 is a diagram for illustrating a path in the embodiment.

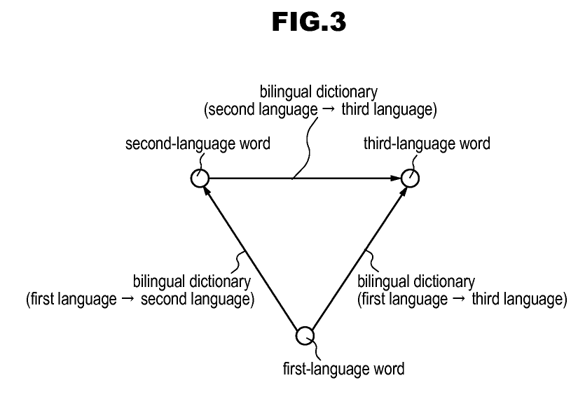

FIG. 4 is a flowchart showing an operation of the parallel translation information generation device according to the embodiment.

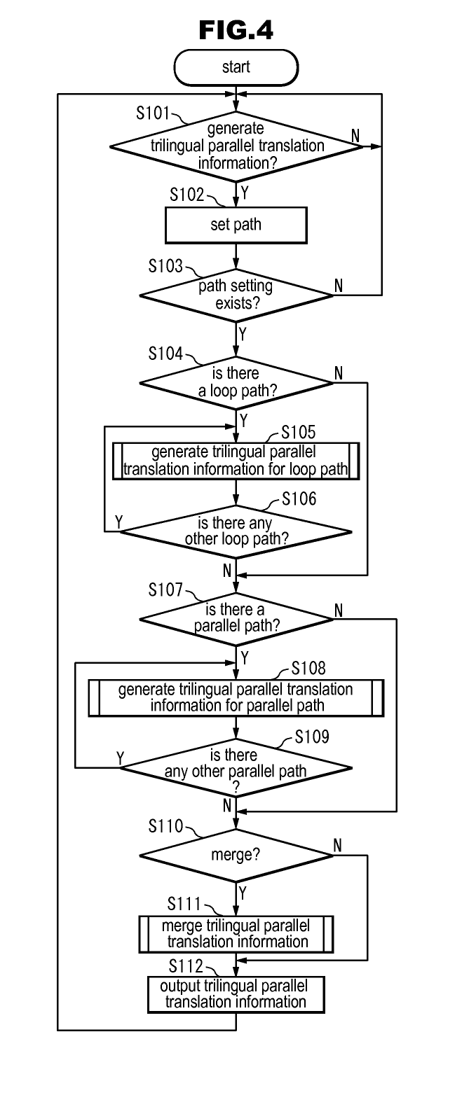

FIG. 5 is a flowchart showing an operation of the parallel translation information generation device according to the embodiment.

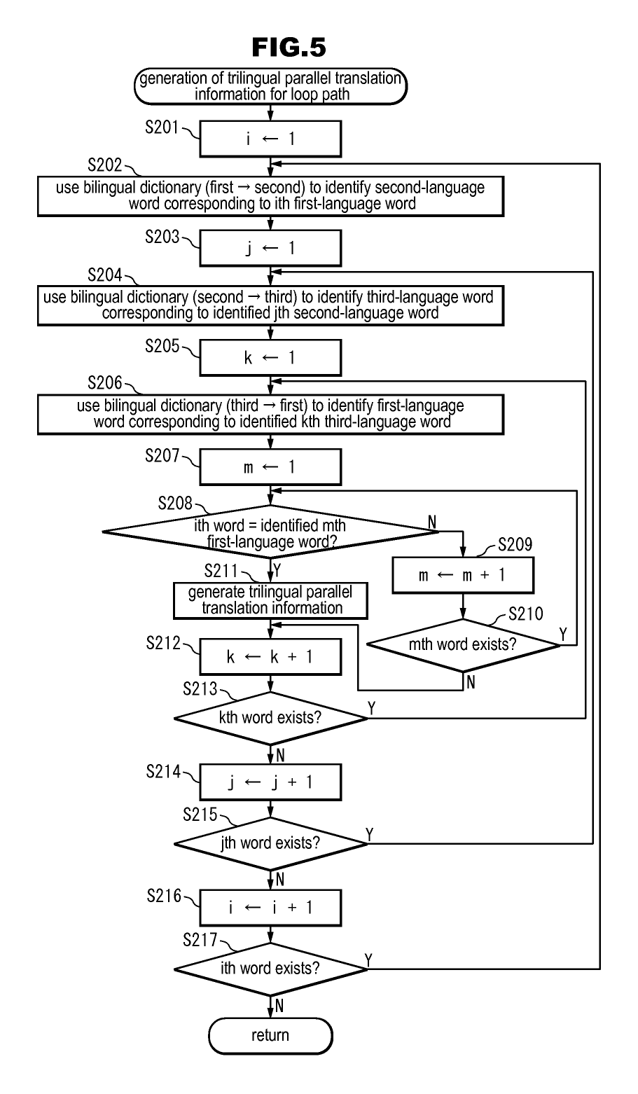

FIG. 6 is a flowchart showing an operation of the parallel translation information generation device according to the embodiment.

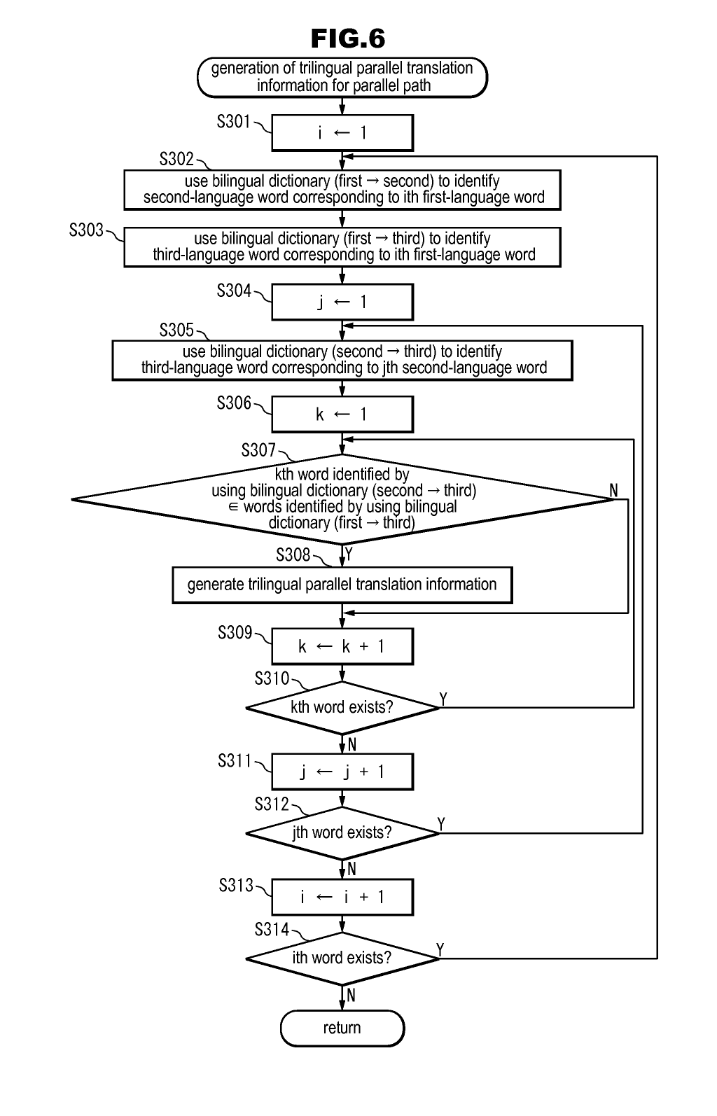

FIG. 7 is a flowchart showing an operation of the parallel translation information generation device according to the embodiment.

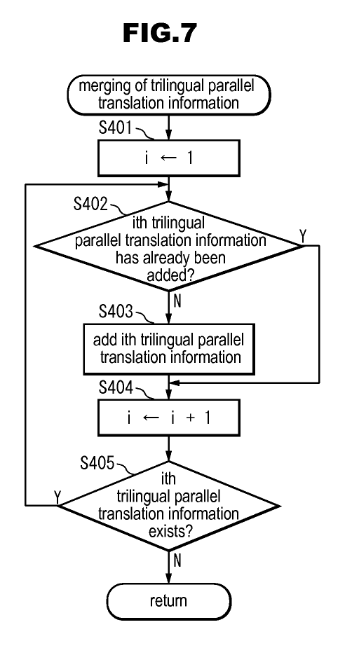

FIG. 8 is a table showing an example of a Japanese-English bilingual dictionary according to the embodiment.

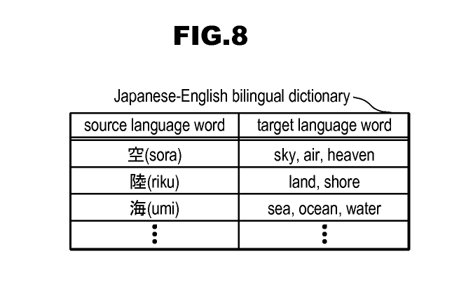

FIG. 9 is a table showing an example of the correspondence between the path type and the bilingual dictionary type in the embodiment.

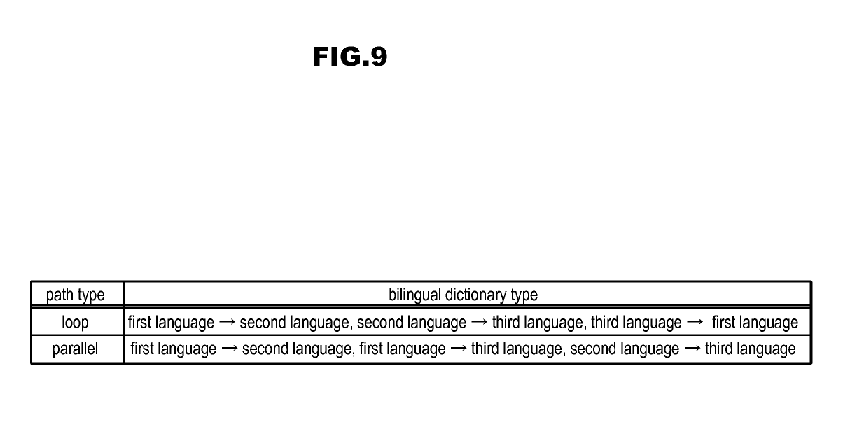

FIG. 10 is a table showing an example of path information that is information indicating a path in the embodiment.

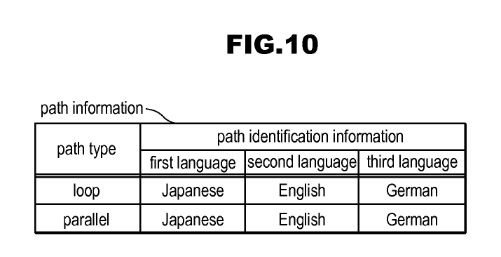

FIG. 11 is a table showing an example of trilingual parallel translation information in the embodiment.

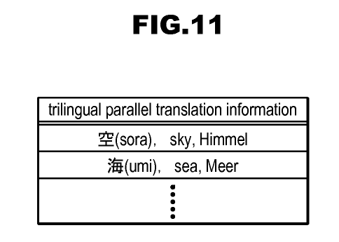

FIG. 12 is a table showing an example of trilingual parallel translation information in the embodiment.

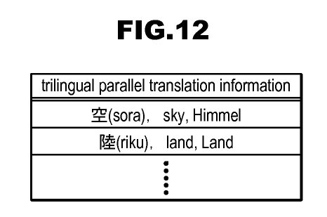

FIG. 13 is a block diagram showing a configuration of a parallel translation information generation device according to Embodiment 2 of the present invention.

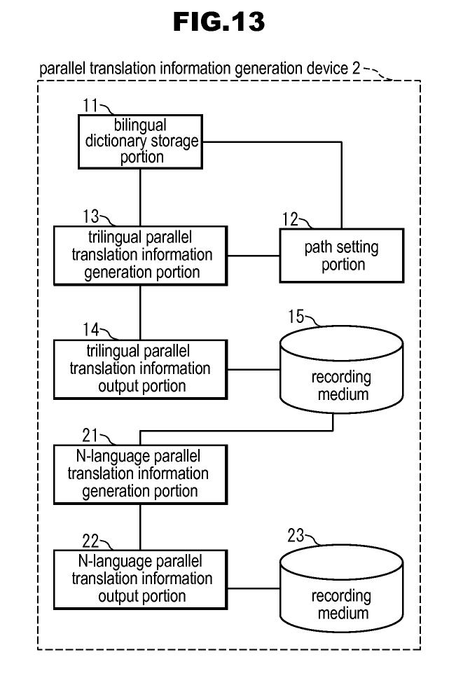

FIG. 14 is a flowchart showing an operation of the parallel translation information generation device according to the embodiment.

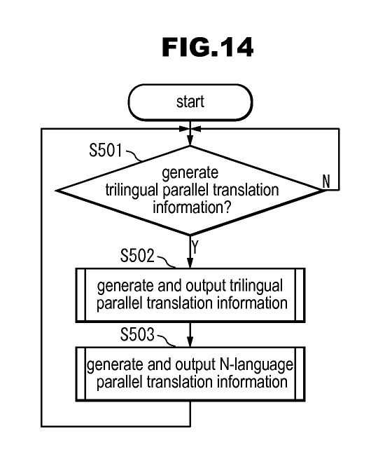

FIG. 15 is a flowchart showing an operation of the parallel translation information generation device according to the embodiment.

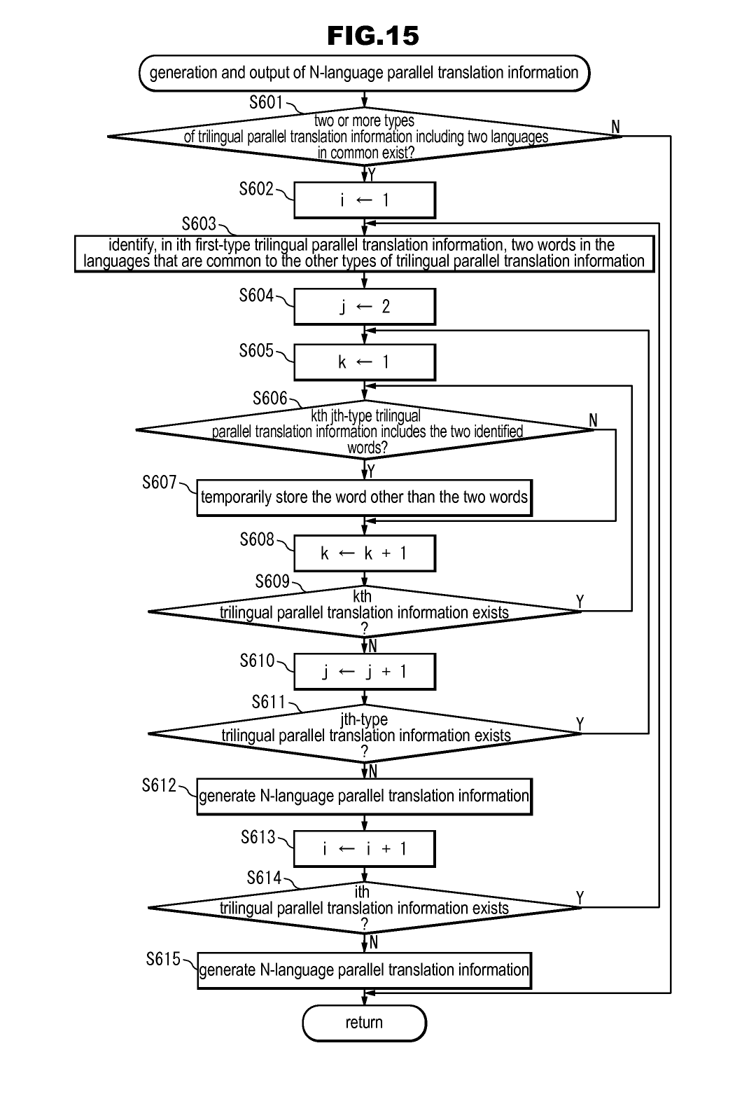

FIG. 16 is a table showing an example of trilingual parallel translation information in the embodiment.

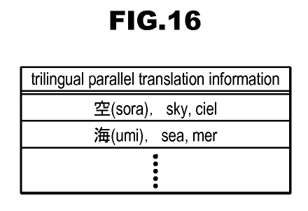

FIG. 17 is a diagram for illustrating the generation of four-language parallel translation information in the embodiment.

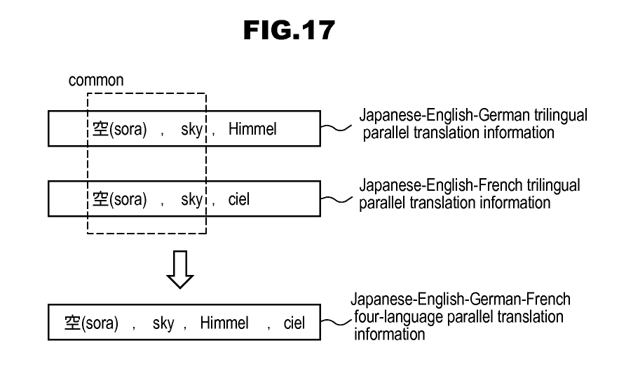

FIG. 18 is a diagram for illustrating the generation of four-language parallel translation information in the embodiment.

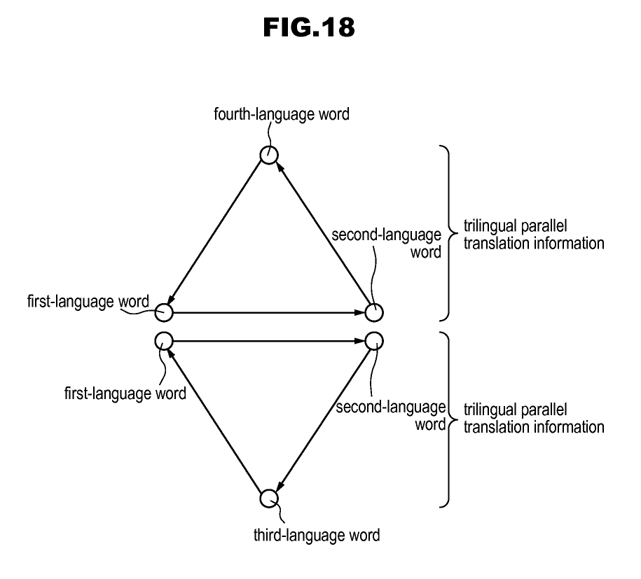

FIG. 19 is a diagram for illustrating the generation of four-language parallel translation information in the embodiment.

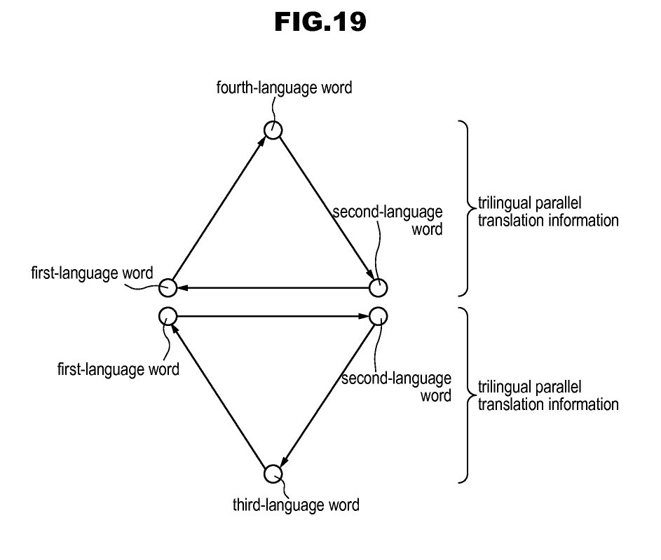

FIG. 20 is a block diagram showing a configuration of a parallel translation information generation device according to Embodiment 3 of the present invention.

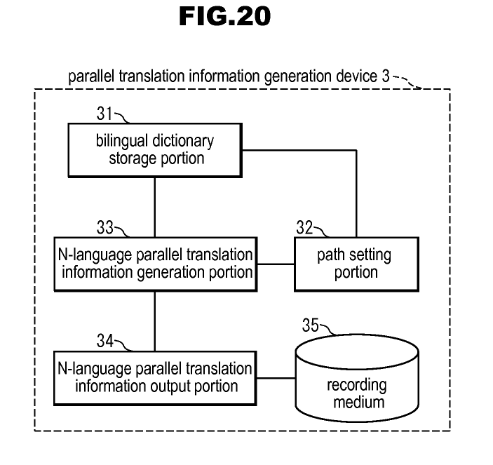

FIG. 21 is a diagram for illustrating a path in the embodiment.

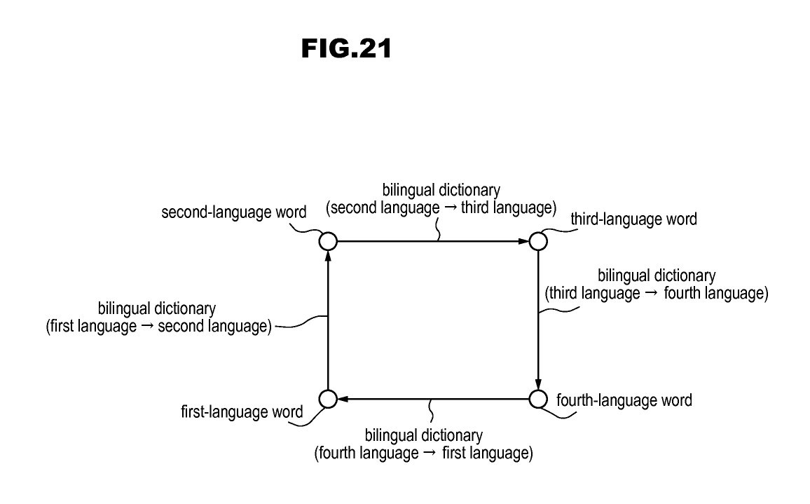

FIG. 22 is a diagram for illustrating a path in the embodiment.

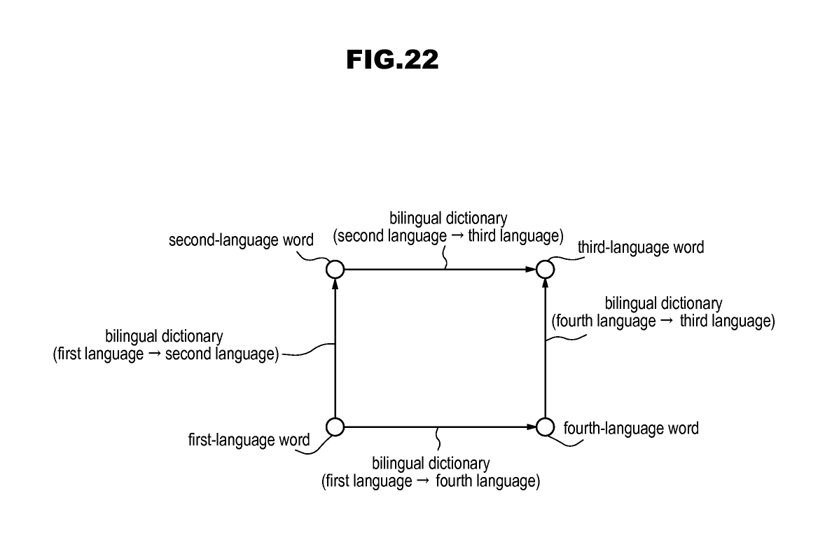

FIG. 23 is a flowchart showing an operation of the parallel translation information generation device according to the embodiment.

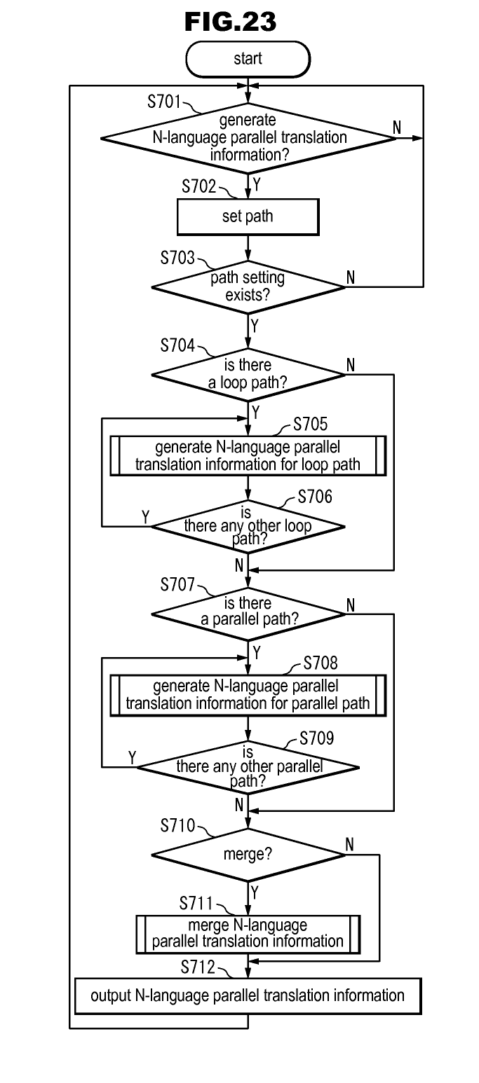

FIG. 24 is a schematic diagram showing an example of an appearance of a computer system in the embodiments.

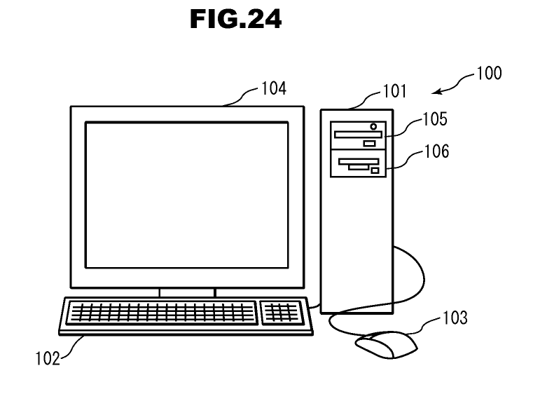

FIG. 25 is a diagram showing an example of the computer system in the embodiments.

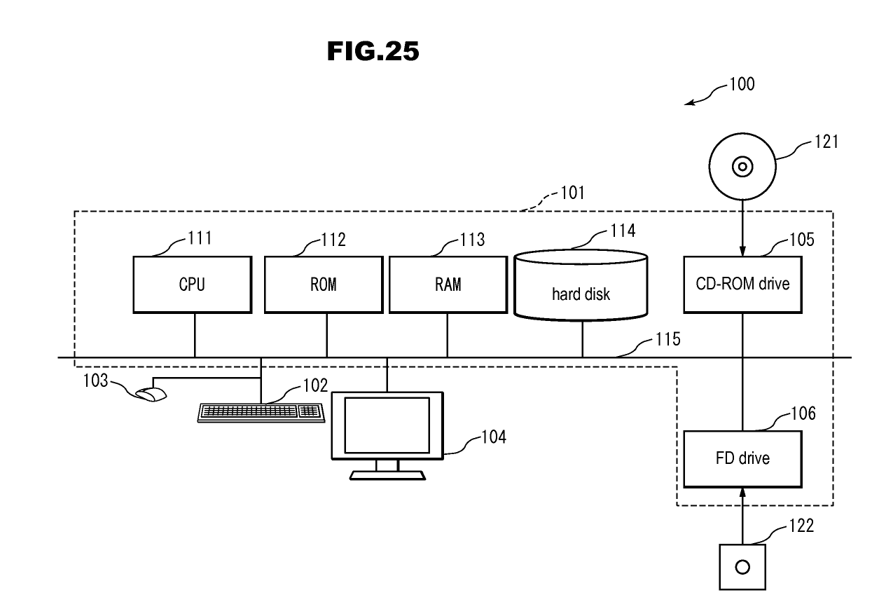

1. A parallel translation information generation device comprising:
a bilingual dictionary storage portion in which are stored three or more types of bilingual dictionaries that are each information associating words in two languages and that link all two-language combinations of a first language, a second language, and a third language;
a trilingual parallel translation information generation portion that generates trilingual parallel translation information that is a set of a word in the first language, a word in the second language, and a word in the third language having a relationship such that all sets of words in two languages among the first-language word, the second-language word, and the third-language word are linked by the bilingual dictionaries stored in the bilingual dictionary storage portion; and
a trilingual parallel translation information output portion that outputs the trilingual parallel translation information generated by the trilingual parallel translation information generation portion.

2. The parallel translation information generation device according to claim 1,
wherein each of the bilingual dictionaries stored in the bilingual dictionary storage portion has a direction from a source language to a target language,
the parallel translation information generation device further comprises a path setting portion that sets an interlingual path such that all two-language combinations of the first language, the second language, and the third language are linked at least in either direction, and
the trilingual parallel translation information generation portion generates the trilingual parallel translation information in which words in two languages are linked in the directions of the path set by the path setting portion.

3. The parallel translation information generation device according to claim 2,
wherein at least a bilingual dictionary having a direction from the first language to the second language, a bilingual dictionary having a direction from the second language to the third language, and a bilingual dictionary having a direction from the third language to the first language are stored in the bilingual dictionary storage portion, and
the path setting portion sets at least a path having the direction from the first language to the second language, the direction from the second language to the third language, and the direction from the third language to the first language.

4. The parallel translation information generation device according to claim 2,
wherein at least a bilingual dictionary having a direction from the first language to the second language, a bilingual dictionary having a direction from the first language to the third language, and a bilingual dictionary having a direction from the second language to the third language are stored in the bilingual dictionary storage portion, and
the path setting portion sets at least a path having the direction from the first language to the second language, the direction from the first language to the third language, and the direction from the second language to the third language.

5. The parallel translation information generation device according to claim 1,
wherein four or more types of bilingual dictionaries that link two-language combinations of four or more languages are stored in the bilingual dictionary storage portion,
the trilingual parallel translation information generation portion generates two or more types of trilingual parallel translation information that include at least two languages that are the same, and
the parallel translation information generation device further comprises
an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and
an N-language parallel translation information output portion that outputs the N-language parallel translation information generated by the N-language parallel translation information generation portion.

6. A parallel translation information generation device comprising:
a bilingual dictionary storage portion in which are stored N or more types of bilingual dictionaries that are each information associating words in two languages and that link an ith language with an (i+1)th language (i is an integer of 1 to N (N is an integer of 3 or more), and an (N+1)th language is a first language);
an N-language parallel translation information generation portion that generates N-language parallel translation information that is a set of words in the first language through an Nth language having a relationship such that all sets of words in two adjacent languages among the first-language word through the Nth-language word are linked by the bilingual dictionaries stored in the bilingual dictionary storage portion; and
an N-language parallel translation information output portion that outputs the N-language parallel translation information generated by the N-language parallel translation information generation portion.

7. A parallel translation information generation method that is performed by using a bilingual dictionary storage portion in which are stored three or more types of bilingual dictionaries that are each information associating words in two languages and that link all two-language combinations of a first language, a second language, and a third language, a trilingual parallel translation information generation portion, and a trilingual parallel translation information output portion, the method comprising:
a trilingual parallel translation information generation step of generating, by the trilingual parallel translation information generation portion, trilingual parallel translation information that is a set of a word in the first language, a word in the second language, and a word in the third language having a relationship such that all sets of words in two languages among the first-language word, the second-language word, and the third-language word are linked by the bilingual dictionaries stored in the bilingual dictionary storage portion, and
a trilingual parallel translation information output step of outputting, by the trilingual parallel translation information output portion, the trilingual parallel translation information generated in the trilingual parallel translation information generation step.

8. A parallel translation information generation method that is performed by using a bilingual dictionary storage portion in which are stored N or more types of bilingual dictionaries that are each information associating words in two languages and that link an ith language with an (i+1)th language (i is an integer of 1 to N (N is an integer of 3 or more), and an (N+1)th language is a first language), an N-language parallel translation information generation portion, and an N-language parallel translation information output portion, the method comprising:
an N-language parallel translation information generation step of generating, by the N-language parallel translation information generation portion, N-language parallel translation information that is a set of words in the first language through an Nth language having a relationship such that all sets of words in two adjacent languages among the first-language word through the Nth-language word are linked by the bilingual dictionaries stored in the bilingual dictionary storage portion; and
an N-language parallel translation information output step of outputting, by the N-language parallel translation information output portion, the N-language parallel translation information generated in the N-language parallel translation information generation step.

9. A computer readable medium having embodied thereon a program, the program being executable by a processor for performing a method for generating parallel translation information, the method comprising:
a trilingual parallel translation information generation step of generating trilingual parallel translation information that is a set of a word in the first language, a word in the second language, and a word in the third language having a relationship such that all sets of words in two languages among the first-language word, the second-language word, and the third-language word are linked by bilingual dictionaries stored in a bilingual dictionary storage portion in which are stored three or more types of bilingual dictionaries that are each information associating words in two languages and that link all two-language combinations of the first language, the second language, and the third language; and
a trilingual parallel translation information output step of outputting the trilingual parallel translation information generated in the trilingual parallel translation information generation step.

10. A computer readable medium having embodied thereon a program, the program being executable by a processor for performing a method for generating parallel translation information, the method comprising:
an N-language parallel translation information generation step of generating N-language parallel translation information that is a set of words in a first language through an Nth language having a relationship such that all sets of words in two adjacent languages among the first-language word through the Nth-language (N is an integer of 3 or more) word are linked by bilingual dictionaries stored in a bilingual dictionary storage portion in which are stored N or more types of bilingual dictionaries that are each information associating words in two languages and that link an ith language with an (i+1)th language (i is an integer of 1 to N, and an (N+1)th language is the first language); and
an N-language parallel translation information output step of outputting the N-language parallel translation information generated in the N-language parallel translation information generation step.

11. The parallel translation information generation device according to claim 3,
wherein at least a bilingual dictionary having a direction from the first language to the second language, a bilingual dictionary having a direction from the first language to the third language, and a bilingual dictionary having a direction from the second language to the third language are stored in the bilingual dictionary storage portion, and
the path setting portion sets at least a path having the direction from the first language to the second language, the direction from the first language to the third language, and the direction from the second language to the third language.

12. The parallel translation information generation device according to claim 11,
wherein four or more types of bilingual dictionaries that link two-language combinations of four or more languages are stored in the bilingual dictionary storage portion,
the trilingual parallel translation information generation portion generates two or more types of trilingual parallel translation information that include at least two languages that are the same, and
the parallel translation information generation device further comprises
an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and
an N-language parallel translation information output portion that outputs the N-language parallel translation information generated by the N-language parallel translation information generation portion.

13. The parallel translation information generation device according to claim 2,
wherein four or more types of bilingual dictionaries that link two-language combinations of four or more languages are stored in the bilingual dictionary storage portion,
the trilingual parallel translation information generation portion generates two or more types of trilingual parallel translation information that include at least two languages that are the same, and
the parallel translation information generation device further comprises
an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and
an N-language parallel translation information output portion that outputs the N-language parallel translation information generated by the N-language parallel translation information generation portion.

14. The parallel translation information generation device according to claim 3,
wherein four or more types of bilingual dictionaries that link two-language combinations of four or more languages are stored in the bilingual dictionary storage portion,
the trilingual parallel translation information generation portion generates two or more types of trilingual parallel translation information that include at least two languages that are the same, and
the parallel translation information generation device further comprises
an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and
an N-language parallel translation information output portion that outputs the N-language parallel translation information generated by the N-language parallel translation information generation portion.

15. The parallel translation information generation device according to claim 4,
wherein four or more types of bilingual dictionaries that link two-language combinations of four or more languages are stored in the bilingual dictionary storage portion,
the trilingual parallel translation information generation portion generates two or more types of trilingual parallel translation information that include at least two languages that are the same, and
the parallel translation information generation device further comprises
an N-language parallel translation information generation portion that merges two or more pieces of the trilingual parallel translation information that include the same words in at least two languages by using the two or more types of trilingual parallel translation information output by the trilingual parallel translation information output portion, and generates N-language parallel translation information (N is an integer of 4 or more) that is a set of words in N or more languages, and
an N-language parallel translation information output portion that outputs the N-language parallel translation information generated by the N-language parallel translation information generation portion.
